(19) United States
(12) Patent Application Publication
(10) Pub. No.: US 2025/0156597 A1
(43) Pub. Date: May 15, 2025

(54) COMPUTER AIDED AUTOMATED SHAPE SYNTHESIS OF PLATE-LIKE STRUCTURES

(71) Applicant: Autodesk, Inc., San Francisco, CA (US)

(72) Inventors: Ravi Kumar Burla, Novi, MI (US); Benjamin McKittrick Weiss, Tualatin, OR (US); Marcin Makowski, Kraków (PL); Marcin Jan Rakus, Olkusz (PL); Jesus Rodriguez, Farmington, MI (US)

(21) Appl. No.: 18/507,958

(22) Filed: Nov. 13, 2023

(51) Int. Cl. G06F 30/20; G06F 30/12; G06F 119/18

(52) U.S. Cl. CPC G06F 30/20; G06F 30/12; G06F 2119/18

(57) ABSTRACT

Methods, systems, and apparatus, including medium-encoded computer program products, for automated shape synthesis including obtaining two or more specified regions of geometry defined in a data structure used by the shape synthesis computer program, producing candidate solutions, each candidate solution of the candidate solutions produced using a different plate generation algorithm to synthesize plates that join the two or more specified regions of geometry with each other through the plates, each of the plates is defined by a base plane, a 2D profile, and a thickness, where the candidate solutions represent new geometry defined in the data structure, and providing, for presentation in a user interface, the candidate solutions and controls to select one or more of the candidate solutions for use in manufacturing one or more physical structures using one or more computer-controlled manufacturing systems, or for use in displaying the selected candidate solutions on a display screen.

### BACKGROUND

This specification relates to computer aided design of physical structures, which can be manufactured using additive manufacturing, subtractive manufacturing and/or other manufacturing systems and techniques, or other structures, which can be provided as a digital asset, such as for use in animation.

Computer Aided Design (CAD) software has been developed and used to generate three-dimensional (3D) representations of objects, and Computer Aided Manufacturing (CAM) software has been developed and used to evaluate, plan and control the manufacture of the physical structures of those objects, e.g., using Computer Numerical Control (CNC) manufacturing techniques. Typically, CAD software stores the 3D representations of the geometry of the objects being modeled using a boundary representation (B-Rep) format. A B-Rep model is a set of connected surface elements specifying boundaries between a solid portion and a non-solid portion of the modeled 3D object. In a B-Rep model (often referred to as a B-Rep), geometry is stored in the computer using smooth and precise mathematical surfaces, in contrast to the discrete and approximate surfaces of a mesh model, which can be difficult to work with in a CAD program.

CAD programs have been used in conjunction with subtractive manufacturing systems and techniques. Subtractive manufacturing refers to any manufacturing process where 3D objects are created from stock material (generally a “blank” or “workpiece” that is larger than the 3D object) by cutting away portions of the stock material. Such manufacturing processes typically involve the use of multiple CNC machine cutting tools in a series of operations, starting with a roughing operation, an optional semi-finishing operation, and a finishing operation. In addition to CNC machining, other subtractive manufacturing techniques include electrode discharge machining, chemical machining, waterjet machining, etc. In contrast, additive manufacturing, also known as solid free form fabrication or 3D printing, refers to any manufacturing process where 3D objects are built up from raw material (generally powders, liquids, suspensions, or molten solids) in a series of layers or cross-sections. Examples of additive manufacturing include Fused Filament Fabrication (FFF) and Selective Laser Sintering (SLS). Other manufacturing techniques for building 3D objects from raw materials include casting and forging (both hot and cold) and molding.

In addition, CAD software has been designed to perform automatic generation of 3D geometry of one or more parts in a design (known as “topology optimization”, “generative design”, or “generative modelling”, among others). This automated generation of 3D geometry often works within a “design domain” specified by a user or the CAD software and generates geometry typically by optimizing design objectives and respecting design constraints, which can be defined by the user, CAD software, or a third party. The design objectives can include but are not limited to minimizing waste material, minimizing the weight of the part, and minimizing the compliance, stress, maximum mass, maximum deflection under load, or other intrinsic property of the part, and are used to drive the shape synthesis process towards better designs. Though not required, it is typical for a design objective to be rooted in a simulation of the design (linear static, fluid dynamic, electromagnetic, etc.). Design constraints can include a variety of physical characteristics or behaviors that must be met in any generated design (requirements, either on individual parts or on the entire assembly, are also admissible); examples include maximum mass, maximum deflection under load, maximum stress, etc.

Geometric constraints may also be provided, for example to ensure the generated shape has no tiny features or is more easily realized using a particular manufacturing process. Further, the geometric inputs to such a 3D geometry generation tool can include one or more user- or CAD system-provided “preserves” (indicating volumetric regions of the design space that should be filled in with material in a final design) or “preserve faces” (indicating interfaces between the design space and an adjacent component that should be contacted by the generated 3D geometry) which should always be present in the design. Other regions in which geometry should or should not be generated can also be provided in a similar manner (e.g., “obstacle bodies” used to indicate where geometry should not be created). In some cases, the shape synthesis process takes place using a different representation of geometry than that employed by the CAD system. For example, a CAD system might use a boundary representation (“B-Rep”) while the geometry generation engine might employ a level set function embedded in a voxel or tetrahedral mesh.

### SUMMARY

This specification describes technologies relating to computer aided design of structures using plate-like structures to perform shape synthesis, e.g., during automated design of physical structures. The systems and techniques described can be used with computer aided design of three-dimensional (3D) geometry when two or more regions of a shape should be, or should remain, connected with each other. Also, while the present disclosure focuses on automated shape synthesis of plate-like structures, the systems and techniques described are applicable in other technical fields of endeavor, including for assessing the connectivity of a design, or as a standalone geometry synthesis method, e.g., to create a starting shape for use in shape and/or topology optimization. Other applications include generation of conceptual work or digital-only assets, such as for use in animation.

In general, one or more aspects of the subject matter described in this specification can be embodied in one or more methods (and also one or more non-transitory computer-readable mediums tangibly encoding a computer program operable to cause data processing apparatus to perform operations), including: obtaining, by a shape synthesis computer program, two or more specified regions of geometry defined in a data structure used by the shape synthesis computer program. The shape synthesis computer program produces candidate solutions, each candidate solution of the candidate solutions produced using a different plate generation algorithm to synthesize plates that join the two or more specified regions of geometry with each other through the plates, each of the plates is defined by a base plane, a two-dimensional profile, and a thickness, and where the candidate solutions represent new geometry defined in the data structure. The shape synthesis computer program provides, for presentation in a user interface, the candidate solutions and controls to select one or more of the candidate solutions for use in manufacturing one or more physical structures corresponding to the selected one or more candidate solutions using one or more computer-controlled manufacturing systems, or for use in displaying the selected one or more candidate solutions on a display screen. Other embodiments of this aspect include corresponding computer systems, apparatus, and computer programs recorded on one or more computer storage devices, each configured to perform the actions of the methods.

In general, another innovative aspect of the subject matter described in this specification can be embodied in one or more methods (and also one or more non-transitory computer-readable mediums tangibly encoding a computer program operable to cause data processing apparatus to perform operations), including: receiving, by a shape synthesis computer program, two or more preserves defined in a data structure used by the shape synthesis computer program. The shape synthesis computer program produces a candidate solution by synthesizing plates that join the two or more preserves with each other through the plates, where each of the plates is defined by a base plane, a two-dimensional profile, and a thickness, and where the candidate solution represents a new geometry defined in the data structure. The producing includes assessing preserve geometry for each of the two or more preserves, generating, from the two or more preserves, an initial shape inclusive of the two or more preserves, generating, based on the preserve geometries of the two or more preserves, a set of candidate plates, where each candidate plate contacts at least one of the two or more preserves, and selecting, from the set of candidate plates, at least two candidate plates to form the candidate solution. The shape synthesis computer program provides the candidate solution for use in manufacturing a physical structure corresponding to the candidate solution using one or more computer-controlled manufacturing systems, or for use in displaying the candidate solution on a display screen. Other embodiments of this aspect include corresponding computer systems, apparatus, and computer programs recorded on one or more computer storage devices, each configured to perform the actions of the methods.

In general, another innovative aspect of the subject matter described in this specification can be embodied in one or more methods (and also one or more non-transitory computer-readable mediums tangibly encoding a computer program operable to cause data processing apparatus to perform operations), including: receiving, by a shape synthesis computer program, two or more preserves defined in a data structure used by the shape synthesis computer program. The shape synthesis computer program produces a candidate solution by synthesizing candidate plates that join the two or more preserves with each other through the candidate plates, where each of the candidate plates is defined by a base plane, a two-dimensional profile, and a thickness, and where the candidate solution represents a new geometry defined in the data structure. The producing includes determining a number of preserves in a current set of preserves defined in the data structure, and in response to determining the number of preserves in the current set of preserves is greater than or equal to two, iteratively selecting candidate plates for inclusion in the candidate solution. The iteration includes classifying each preserve of the current set of preserves defined in the data structure into shape classifications based in part on one or more symmetries of the preserve, selecting a set of base planes for a set of candidate plates from predefined plate configurations stored in a repository and based on the shape classifications of the current set of preserves, generating a ranking for the candidate plates, where a rank of each candidate plate with respect to each other candidate plate of the candidate plates corresponds to (A) a number of the current set of preserves contacting the candidate plate and (B) a classification of the predefined plate configuration in the repository, selecting, from the ranked set of candidate plates, a candidate plate to form the candidate solution, and updating the current set of preserves to include the candidate plate as a new preserve in a next iteration. In response to determining the number of preserves in the current set of preserves is less than two, the shape synthesis computer program provides the candidate solution for use in manufacturing a physical structure corresponding to the candidate solution using one or more computer-controlled manufacturing systems, or for use in displaying the candidate solution on a display screen. Other embodiments of this aspect include corresponding computer systems, apparatus, and computer programs recorded on one or more computer storage devices, each configured to perform the actions of the methods.

Particular embodiments of the subject matter described in this specification can be implemented to realize one or more of the following advantages.

The methods described can be applied to provide new and alternative configurations for plate-based design problems across different domains. The methods described can be used to synthesize (and optionally, optimize) rapid design of welded plate structures, while reducing a user burden when setting up an optimization of a welded plate structure in a design space. As used herein, a “welded plate structure” refers to a design formed from flat or nearly-planar plates of material, for example, by using welding, joining, bonding, or other similar techniques.

Beyond shape and/or topology optimization in generative design or automated modeling, the techniques described herein can be applied in the more general mechanical part and assembly design contexts, where it can be used as an automation or acceleration to user workflows by suggesting layout of welded components during the design process. It can also be used in the design of larger architectural structures where similar compound plate structures are commonly found.

In addition, the technology described can be used to improve automated modeling, which can be an input to a topology optimization process, but does so much more quickly (in minutes, not hours, using current computer processors) and without a starting shape or physical boundary conditions, such as are typically used in generative design.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A shows an example of a system usable to facilitate computer aided design of structures with shape synthesis of plate-like structures.

FIG. 1B shows an example of a process of automated modeling, generative design, and/or shape synthesis.

FIG. 2 is a flow diagram of an example of a process for producing candidate solutions.

FIG. 3 is a flow diagram of an example of a process for producing an alternative candidate solution.

FIG. 4 is a flow diagram of an example of a process for disconnection filtering.

FIG. 5 is a flow diagram of an example for performing a split and bound process.

FIG. 6A is a flow diagram of an example of a process for processing a candidate solution for input to a shape and/or topology optimization process.

FIG. 6B is a flow diagram of another example of a process for processing a candidate solution for input to a shape and/or topology optimization process.

FIG. 7A depicts an example of a set of specified regions in a design space.

FIGS. 7B-7E depict examples of candidate solutions.

FIGS. 8A-8F depict an example of a shape synthesis process.

FIGS. 9A-9H depict an example of a process for resolving disconnections.

FIGS. 10A-10F depict another example of a process for resolving disconnections.

FIGS. 11A-11B depict another example of a process for resolving disconnections.

FIGS. 12A-12D depict examples of split and bound processes.

FIGS. 13A-13F depict examples of split and bound processes.

FIGS. 14A-14C depicts examples of classifications of candidate plate intersections.

FIGS. 15A-15F depict examples of convex hull profiles.

FIG. 16 is a flow diagram of an example of a process of the single-plate based approach for shape synthesis.

FIG. 17 is a flow diagram of an example of a process for surface mesh clustering.

FIG. 18 is a flow diagram of an example process for scoring candidate plates.

FIG. 19 is a flow diagram of an example of a process for generating candidate plates.

FIG. 20 is a flow diagram of an example of a process for selecting candidate plates using preserve classification.

FIG. 21A is a flow diagram of an example of a process for resolving disconnections.

FIG. 21B is a flow diagram of another example of a process for resolving disconnections.

FIG. 22 is a flow diagram of an example process for adding an additional connecting plate to improve a system score.

FIGS. 23A-23F depict examples of a mesh clustering process.

FIG. 24 depicts examples of classifications of preserves.

FIGS. 25A-25E depict examples of extruding candidate plates.

FIGS. 26A-26B depict an example of adjusting candidate plate thickness.

FIG. 27 is a flow diagram of an example of a process of the multi-preserve-based approach for shape synthesis.

FIG. 28 is a flow diagram of an example of a process for disconnection prevention using a connected components map.

FIG. 29 is a flow diagram of an example of a process for generating and selecting candidate plates.

FIG. 30 is a flow diagram of an example of a process for selecting and filtering candidate plates against a database of validated candidate plates.

FIG. 31 is a flow diagram of an example of a process for filtering plates.

FIG. 32 depicts a table of examples of plate configurations for the simple database approach.

FIG. 33 depicts a table including examples of acceptable configurations for candidate plates.

FIG. 34 depicts an example of adjusting candidate plate thickness.

FIGS. 35A-35B depicts examples of candidate solutions for a set of preserves.

FIG. 36 is a schematic diagram of a data processing system including a data processing apparatus, which can be programmed as a client or as a server, and implement the techniques described in this document.

Like reference numbers and designations in the various drawings indicate like elements.

### DETAILED DESCRIPTION

In general, this specification is related to methods for shape synthesis by automating an initial configuration of plates (e.g., location, thickness, boundaries, and 2D profile) without any required input from the user beyond the preserve and obstacle geometries.

More particularly, this specification describes four approaches for generating the initial configuration of plates to produce a 3D object connecting two or more preserves. Preserves, as used in this specification, can be defined as surfaces and/or solid bodies to be connected through the set of plates to produce the 3D object, e.g., input by a user through a user interface of the shape synthesis computer program. The methods described include orienting and sizing one or more planar sheets of material (plates) given a set of preserve and obstacle entities. In an automated shape modeling context, preserves can be provided as surfaces (e.g., faces of a body or surface feature, provided in surface mesh format) and/or preserves can be specified as bodies (e.g., water-tight surface meshes). In general, the approaches and algorithms detailed in this specification can be applied to a given surface or solid preserve(s) in any suitable form (i.e., which can be internally tessellated to triangles) and one or more obstacles as one or more bodies in any suitable format (i.e., which can be tessellated to a water tight triangular surface mesh).

The approaches discussed herein seek to achieve a 3D model generated from a high-quality set of plate specifications for a given problem. “High-quality,” as used here, refers to plate(s) that are similar to those which a user would design by hand, in other words, plate(s) meeting a set of quality criteria, where a set of plates produced will be “connected” (i.e., contacting each preserve in some substantive way such that the geometry in the all plates connects each preserve to every other preserve). The set of quality criteria can also include: (A) using a reasonably small number of plates (i.e., less than one plate per preserve surface), (B) contacting preserve surfaces in a manner that is easy to represent in CAD and manufacture (e.g., having a preference for right angles and circles over oblique angles and ellipses), (C) selecting, where possible, orthogonal plate intersections, with minimally overlapping geometry where two plates intersect, and (D) maintaining a uniform thickness across all plates unless varying the thickness significantly improves the output design.

Generally, each of the four approaches described herein include a shape synthesis process including (1) generating candidate plates from the design space, (2) scoring and/or classifying the plates and selecting from the candidate plates for inclusion in the solution, and (3) refining the plates selected for inclusion in the solution. Optionally, the shape synthesis process includes (4) a process to modify junctions and overlap in the plates selection to form the solution. The subprocesses (1)-(4) can be performed in varying orders including repetition of one or more subprocesses, depending on an approach applied to the shape synthesis process as described in further detail below.

In some implementations, the methods described here can be used to synthesize designs directly in addition to providing a configuration (a 3D model) to a secondary process, e.g., to a topology optimization process. Once a plate configuration is generated, a prismatic filter or other approaches can be used to constrain topology optimization to co-optimize the geometry that should occupy each plate defined in the configuration, as described in further detail below.

As used in this specification a “plate” (also referred to herein as “candidate plate”) is generally defined by four parameters: (A) a base plane (midplane, or the plane of the top or bottom face), (B) a thickness above/below the base plane's normal direction, (C) a domain inside which the plate must remain (i.e., during subsequent optimization), and (D) a profile or other specification of the shape that should be extruded to form the plate. In some implementations, a less complete definition for “plate” can be acceptable, or there may be domain-specific approaches for selecting one or more of the plate parameters. For example, a shell-based topology optimization code can be operable to automatically select plate thickness, or if no optimization is to be performed, the domain of the plate may not be required.

Generally, a shape synthesis computer program is described that is configured to perform the methods of (A) creating candidate plates by examining a problem context (e.g., including two or more preserves, obstacle(s), etc. within the design space), (B) scoring and/or classifying plates and selecting candidate plates for inclusion in final plate set to form the candidate solution, (C) refining the plate set to resolve disconnections and/or further improve the quality of the result by adding or adjusting the candidate plates selected to form the candidate solution, and (optionally) (D) split and bound plates to clean/handle junctions and avoid overlapping plates. Each of these steps can be implemented using a variety of approaches described herein, and effective plate configurations can be created using various combinations of the approaches described herein.

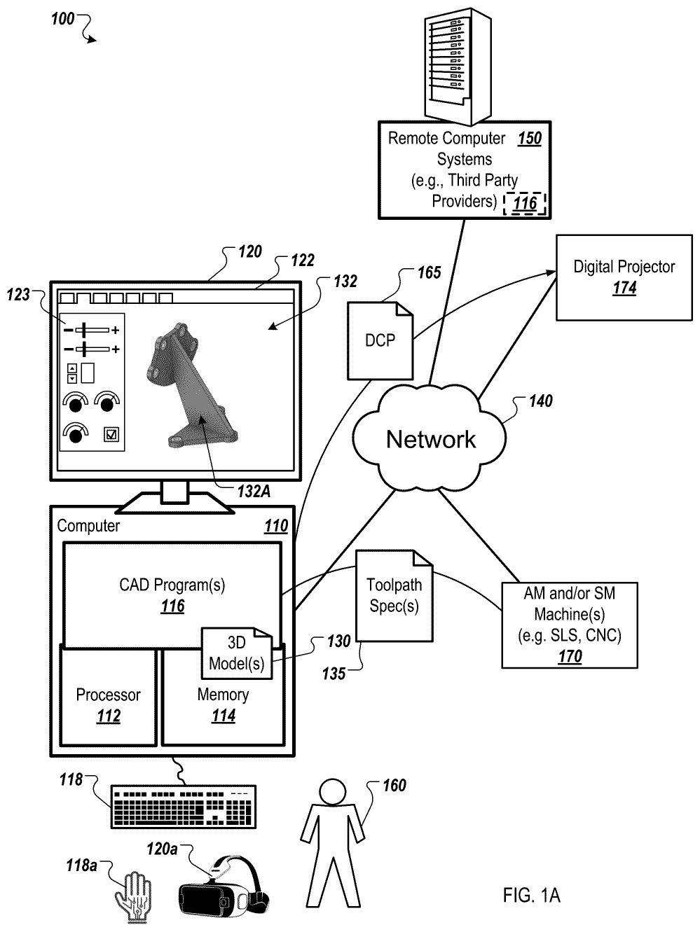

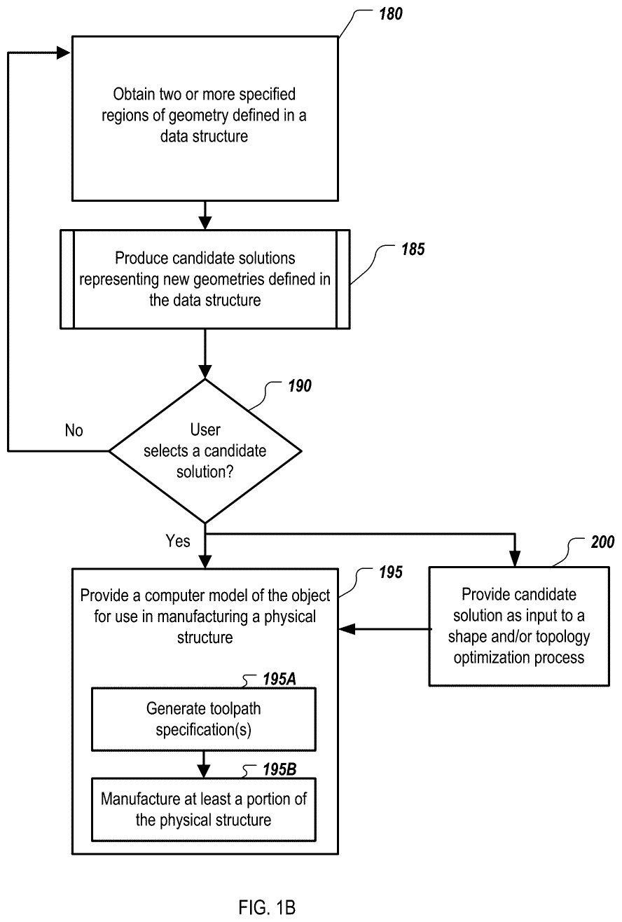

FIG. 1A shows an example of a system 100 usable to facilitate computer aided design of structures with shape synthesis of plate-like structures. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including Computer Aided Design (CAD) program(s) 116, which implement two-dimensional (2D) and/or three-dimensional (3D) modeling functions and include shape synthesis, and which can be implemented as part of one or more generative design processes for topology optimization, e.g., using at least one level-set method as described, in other applications of topology optimization, e.g., automated modeling, and/or for assessing the connectivity of the geometry of a design or as a standalone geometry synthesis method.

In some instances, an output of the systems and techniques described in this document can be provided as input to a numerical simulation (e.g., topology optimization) that can simulate one or more physical properties and can use one or more types of simulation to produce a numerical assessment of physical response (e.g., structural response) of the modeled object. For example, finite element analysis (FEA), including linear static FEA, finite difference method(s), and material point method(s) can be used. Further, the simulation of physical properties can include Computational Fluid Dynamics (CFD), Acoustics/Noise Control, thermal conduction, computational injection molding, electric or electro-magnetic flux, and/or material solidification (which is useful for phase changes in molding processes) simulations.

As used herein, CAD refers to any suitable program used to design physical structures that meet design requirements, regardless of whether or not the program is capable of interfacing with and/or controlling manufacturing equipment. Thus, CAD program(s) 116 can include Computer Aided Engineering (CAE) program(s), Computer Aided Manufacturing (CAM) program(s), etc. The program(s) 116 can run locally on computer 110, remotely on a computer of one or more remote computer systems 150 (e.g., one or more third party providers' one or more server systems accessible by the computer 110 via the network 140) or both locally and remotely. Thus, a CAD program 116 can be two or more programs that operate cooperatively on two or more separate computer processors in that one or more programs 116 operating locally at computer 110 can offload processing operations (e.g., shape synthesis and/or physical simulation operations) “to the cloud” by having one or more programs 116 on one or more computers 150 perform the offloaded processing operations. In some implementations, all shape synthesis operations are run by one or more programs in the cloud and not in a shape representation modeler (e.g., B-Rep modeler) that runs on the local computer. Moreover, in some implementations, the shape synthesis program(s) can be run in the cloud from an Application Program Interface (API) that is called by a program, without user input through a graphical user interface.

The CAD program(s) 116 present a user interface (UI) 122 on a display device 120 of the computer 110, which can be operated using one or more input devices 118 of the computer 110 (e.g., keyboard and mouse). Note that while shown as separate devices in FIG. 1A, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 interacts with the CAD program(s) 116 to create and modify 2D and/or 3D model(s), which can be stored in model document(s) 130. In the example shown in FIG. 1A, a 3D model 132 includes geometry 132A that has been automatically generated using a process that employs systems and techniques described in this document. The shape synthesis process can receive a set of preserve regions (e.g., preserve bodies and/or preserve surfaces) (and optionally obstacle(s)) defined in a design environment as input, i.e., “seed geometry”. In some implementations, boundary constraints can be defined with respect such preserve regions, and the starting shape for shape synthesis (and optionally topology optimization) can be formed, for example, as the convex hull of the preserve regions, or be specified by the user. In some implementations, the starting shape can be generated using the systems and techniques described in this document.

In some implementations, a user can specify, through a user interface of the shape synthesis computer program, the two or more specified regions of geometry, e.g., two or more of preserve bodies and/or preserve surfaces. Additionally, in some implementations, the shape synthesis program can receive one or more obstacles through which the two or more preserves cannot be joined in the design space, e.g., specified by a user in a user interface.

The input preserve regions can be unconnected modeled solids or surfaces (e.g., user identified faces of modeled solids), and a shape synthesis process is used to produce new 3D geometry in a design space, which is the volume of space inside which the object is to be designed during shape and/or topology optimization, and where this new 3D geometry connects all the input preserve regions, such as in the example of FIG. 1A. In some cases, the user may explicitly specify the design space. In some implementations, the CAD program(s) 116 can automatically determine the design space. Moreover, while the following discussion focuses on connecting preserve regions in a 3D model, the present disclosure is more generally applicable to automatically generating a 3D shape between two or more specified regions.

The CAD program(s) 116 can implement at least one generative design process, which enables the CAD program(s) 116 to receive as input a 3D model synthesized using the shape synthesis processes described herein and perform shape refinement, e.g., shape and/or topology optimization. The generative design process, e.g., shape and/or topology optimization process, can receive the 3D model(s) as a starting shape input as well as design objective(s) and constraint(s), i.e., design criteria, where the geometric design of the 3D model(s) can be iteratively optimized based on simulation feedback (e.g., based on a numerical, physics simulation). In some instances, multiple 3D models can be received as input by one or more generative design processes and can be assembled to form a new 3D model. Note that, as used herein, “optimization” (or “optimum”) does not mean that the best of all possible designs is achieved in all cases, but rather, that a best (or near to best) design is selected from a finite set of possible designs that can be generated within an allotted time, given the available processing resources.

In any case, note that the shape synthesis process can (and often will) be done using a different representation of geometry than that employed by the CAD program(s) 116 for performing additional shape and/or topology optimization processes on the output 3D model from the shape synthesis process. For example, the CAD program(s) 116 for shape synthesis can use a B-Rep model for the input geometry, while the shape and/or topology optimization processes receiving the output of the shape synthesis process (e.g., in CAD program(s) 116) can employ a level-set function embedded in a voxel or tetrahedral mesh.

Once the user 160 is satisfied with the algorithmically designed model 132, the computer model 132 can be stored as a model document 130 and/or used to generate another representation of the model (e.g., toolpath specifications for a manufacturing process). This can be done upon request by the user 160, or considering the user's request for another action, such as sending the computer model 132 to a manufacturing machine, e.g., additive manufacturing (AM) machine(s) and/or subtractive manufacturing (SM) machine(s) 170, or other manufacturing machinery, which can be directly connected to the computer 110, or connected via a network 140, as shown. This can involve a post-process carried out on the local computer 110 or externally, for example, based on invoking a cloud service running in the cloud, to further process the generated 3D model (e.g., based on considerations associated with manufacturing process(es)) and to export the 3D model to an electronic document from which to manufacture. Manufacturing processes can include, for example, cut-and-weld manufacture and assembly processes, additive manufacturing processes, etc. The post-process can include, for example, adjusting geometry near plate contact to suit a manufacturing process, automatically nesting sheets, creating cutting toolpaths, and weld instructions, etc. Note that an electronic document (which for brevity will simply be referred to as a document) can be a file but does not necessarily correspond to a file. A document may be stored in a portion of a file that holds other documents, in a single file dedicated to the document in question, or in multiple coordinated files. In addition, the user 160 can save or transmit the 3D model for later use. For example, the CAD program(s) 116 can store the document 130 that includes the algorithmically designed model 132.

The CAD program(s) 116 can provide a document 135 (having toolpath specifications of an appropriate format) to a manufacturing tool(s) 170, for example, to one or more of an AM machine, SM machine, 2D cutting machine, robotic-actuated welding/joining system, to produce a physical structure corresponding to at least a portion of the algorithmically designed model 132. For example, the program(s) 116 can provide document 135 to a 2D cutting system, e.g., a water jet cutter, laser cutter, plasma cutter, router, etc., to create the plates, and provide the plates and the document 135 to a human operator and/or robotic-actuated welding or joining system to assemble the plates into the designed structure.

An AM machine 170 can employ one or more additive manufacturing techniques, such as granular techniques (e.g., Powder Bed Fusion (PBF), Selective Laser Sintering (SLS) and Direct Metal Laser Sintering (DMLS)) or extrusion techniques (e.g., Fused Filament Fabrication (FFF), metals deposition). In some cases, the AM machine 170 builds the physical structure directly, and in some cases, the AM machine 170 builds a mold for use in casting or forging the physical structure.

An SM machine 170 can be a Computer Numerical Control (CNC) milling machine, such as a multi-axis, multi-tool milling machine used in the manufacturing process. For example, the CAD program(s) 116 can generate CNC instructions for a machine tool system 170 that includes multiple tools (e.g., solid carbide round tools of different sizes and shapes, and insert tools of different sizes that receive metal inserts to create different cutting surfaces) useable for various machining operations. Thus, in some implementations, the CAD program(s) 116 can provide a corresponding document 135 (having toolpath specifications of an appropriate format, e.g., a CNC numerical control (NC) program) to the SM machine 170 for use in manufacturing the physical structure using various cutting tools, etc.

In addition, in some implementation, no physical manufacturing is involved. The systems and techniques described herein are applicable to any suitable 2D or 3D modelling software. Thus, in some implementations, the CAD program(s) 116 can be animation production program(s) that render the 3D model 132 to a document 165 of an appropriate format for visual display, such as by a digital projector 174 (e.g., a digital cinema package (DCP) 165 for movie distribution) or other high resolution display device. Other applications are also possible.

For convenience, the processes described in this specification will be described as being performed by a “shape synthesis computer program” (i.e., “computer program”) that is operable on a system of one or more computers, located in one or more locations, and programmed appropriately in accordance with this specification. For example, a, e.g., the CAD programs 116 on computer 110 of FIG. 1, appropriately programmed, can perform the processes described herein.

FIG. 1B shows an example of a process of shape synthesis. The shape synthesis computer program obtains 180 two or more specified regions of geometry defined in a data structure. The two or more specified regions can include preserve bodies and/or preserve surfaces (also referred to herein as “preserves”). Additionally, the shape synthesis program can obtain zero or more (e.g., one or more) obstacle regions that must be avoided when joining the specified regions of geometry. The shape synthesis computer program produces 185 candidate solutions, each candidate solution of the candidate solutions produced using a different plate generation algorithm to synthesize plates that join the two or more specified regions of geometry with each other through the plates (also referred to herein as “candidate plates”). Each of the plates is defined by a base plane, a two-dimensional profile and a thickness. The produced candidate solutions represent new geometry defined in the data structure.

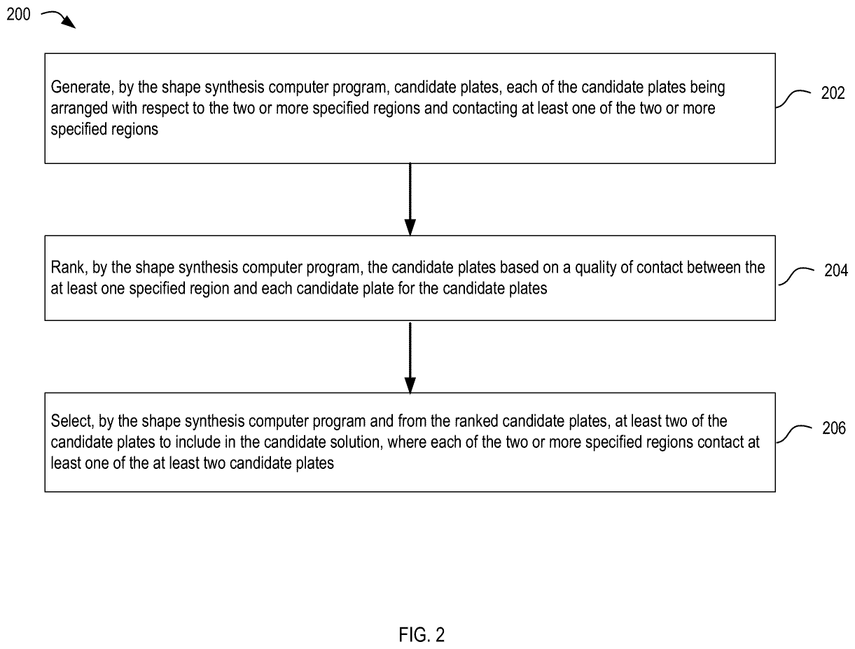

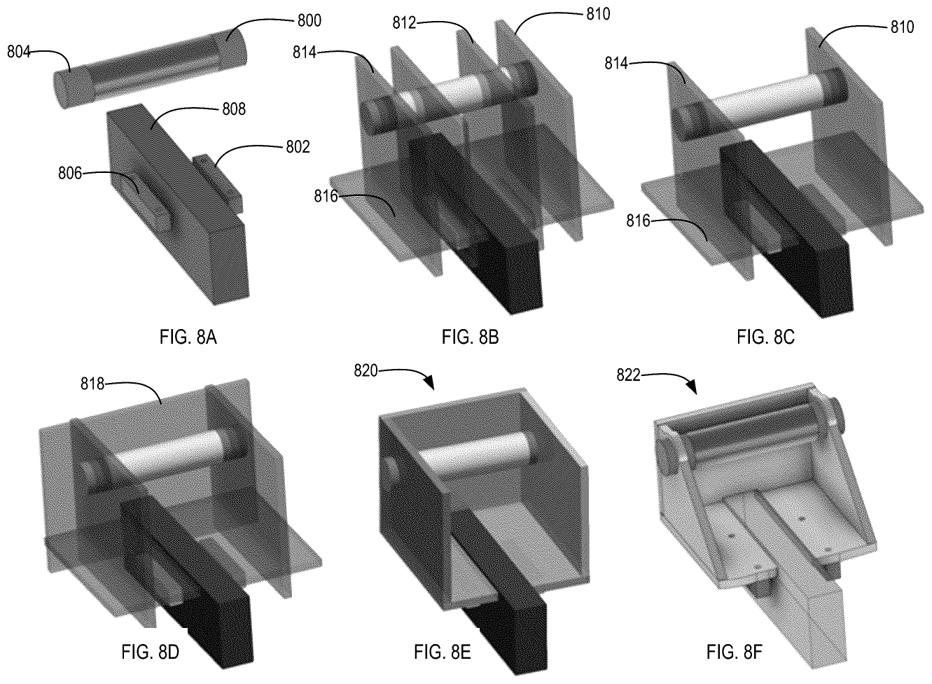

FIG. 2 is a flow diagram of an example of a process 200 for producing candidate solutions, where an example of a solution is depicted in FIGS. 8A, 8B, 8C, 8D, 8E, and 8F. An example problem is depicted in FIG. 8A including a set of preserves 800, 802, 804, and 806 to be connected by one or more candidate plates to produce a candidate solution and an obstacle body 808 that the computer program is to avoid when forming the candidate solution(s).

In some implementations, producing 185 the candidate solutions includes, for each of the candidate solutions, generating 202, by the shape synthesis computer program, candidate plates. The computer program generates a set of candidate plates, e.g., candidate plates 810, 812, 814, and 816, based on the preserves and the obstacle in the design space, e.g., as depicted in FIG. 8B. Each of the candidate plates of the candidate solution is arranged with respect to the two or more specified regions (e.g., preserves, obstacles) and contacting at least one of the two or more specified regions. The shape synthesis computer program ranks 204 each candidate plate of the candidate plates based on a quality of contact between the specified region(s) and the candidate plate.

In some implementations, candidate plates are generated from symmetry planes between the preserves. The symmetry planes can be used to form midplanes of candidate plates. Symmetry planes are often a logical choice for plate location because they maintain the symmetry of the problem, are centrally located, and visually appealing. In addition, candidate plates can be created parallel to the symmetry plane in pairs at various distances in the normal/anti-normal direction, using a plate series. If selected plates are already present, the computer program creates candidate plates by reflecting each selected plate around each symmetry plane to generate new candidates. In some cases, partial symmetry planes can also be considered, in which only a subset of the preserves and/or obstacles is included in the symmetry detection.

In some implementations, the computer program can rank the candidate plates using base planes corresponding to the candidate plates. In other words, candidate plates having base planes corresponding to one or more identified symmetry planes of the specified regions can be assigned higher rankings than candidate plates having base planes not corresponding to the one or more identified symmetry planes. For example, a candidate plate having a base plane that corresponds to (e.g., aligns with) a symmetry plane identified for the two or more preserves of the set of preserves can be assigned a higher rank than a candidate plate where the base plane of the candidate plate does not align with an identified symmetry plane.

In some implementations, selecting a candidate plate from the set of ranked candidate plates includes iteratively selecting candidate plates from the set of ranked candidate plates to include in the candidate solution. As described in further detail below, the candidate plates can be selected iteratively, with a re-ranking of the remaining candidate plates occurring after each selection of a candidate plate. In one example, ranking (i.e., re-ranking) the candidate plates can further include ranking the candidate plates using an angle of intersection of the candidate plate with one or more of (e.g., each of) the previously selected candidate plate of the candidate plates. In another example, ranking (i.e., re-ranking) the candidate plates can further include ranking the candidate plates based on an orientation of the candidate plate with respect to at least one other previously selected candidate plate. An orientation of the candidate plate with respect to another candidate plate previously included in the candidate solution can be defined as (A) a degree of orthogonality of the candidate plate with respect to the at least one other candidate plate, and/or (B) a separation of a planar surface of the candidate to a parallel planar surface of the at least one other candidate plate.

In another example, ranking (i.e., re-ranking) the remaining set of candidate plates can be performed based in part on the angles of intersection and/or orientation of each of the remaining set of candidate plates with respect to the candidate plates that have previously been selected to include in the solution. As such, the ranking of a candidate plate with respect to each other candidate plate can change based on the previously selected plates included in the candidate solution.

In some implementations, a quality of contact between at least one specified region (e.g., thickened preserve surface or preserve body) and the candidate plate can be determined by the computer program from a characteristic of an intersection between a midplane of the candidate plate with the at least one specified region. A characteristic of the intersection can include, for example, a containment of the preserve within the candidate plate. In another example, a characteristic of the intersection can include a crossing of the preserve of the midplane of the candidate plate. The quality of contact can be measured as a degree to which the characteristic is met, e.g., a degree to which the preserve is contained within the candidate plane.

Referring back to FIG. 2, the shape synthesis computer program selects 206 at least two candidate plates to include the solution from the ranked set of candidate plates, where the candidate solution includes each of the two or more specified regions contacting at least one of the at least two candidate plates. As depicted in FIG. 8C, the computer program can select, from the ranked set of candidate plates, a subset of candidate plates to form the candidate solution, e.g., candidate plates 810, 814, and 816.

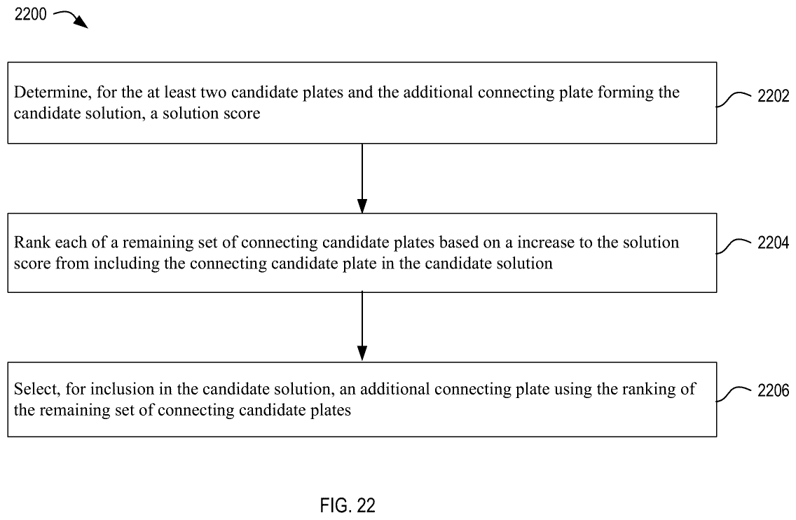

In some implementations, as described with reference to FIG. 22, the computer program may determine whether to add an additional candidate plate for inclusion in the candidate solution, e.g., to resolve a disconnection or otherwise improve a score of the candidate solution. For example, as depicted in FIG. 8D, an additional candidate plate 818 is added to ensure connectivity of the set of candidate plates included in the candidate solution.

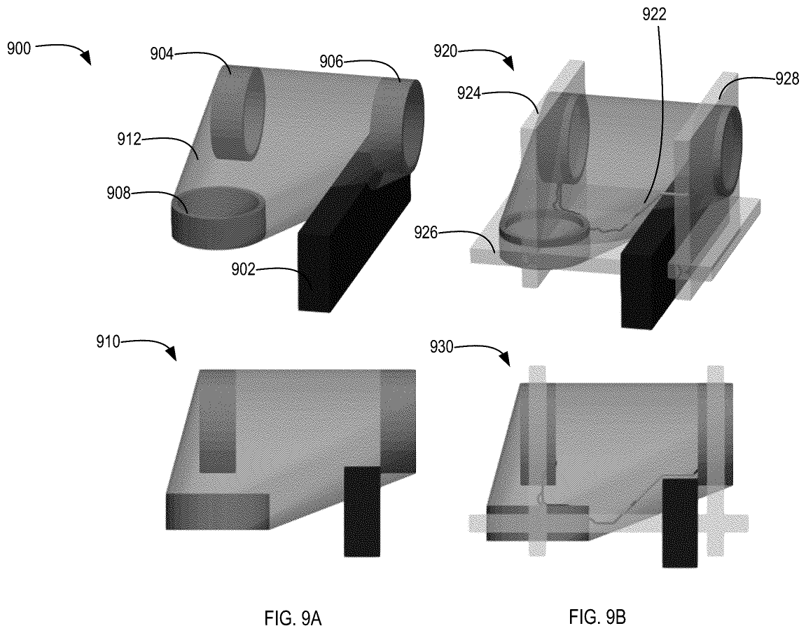

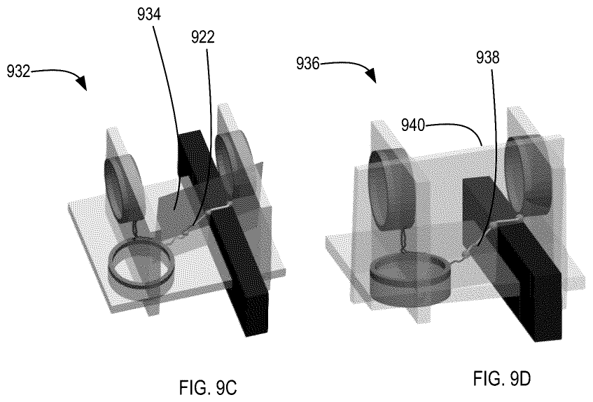

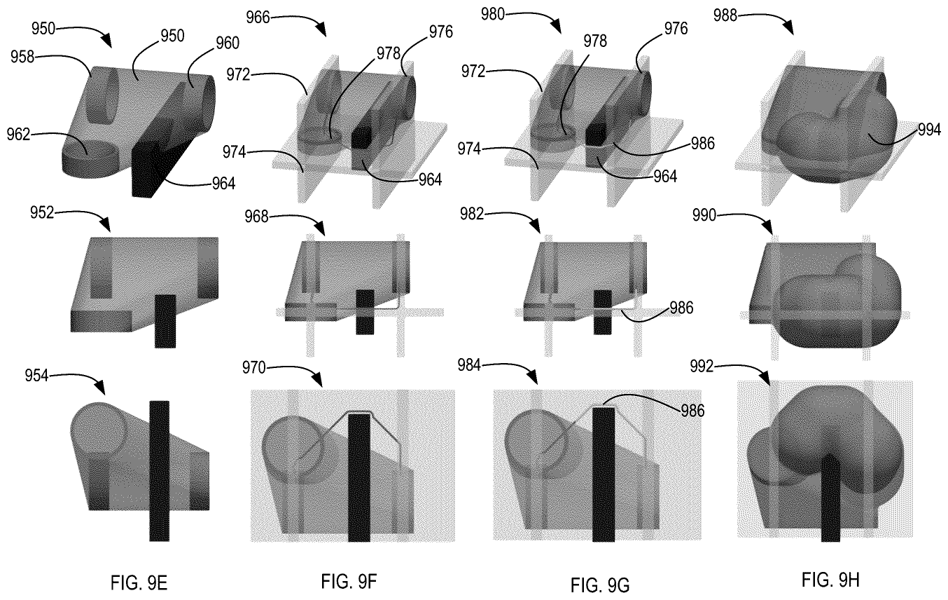

In some implementations, as described in further detail with reference to FIGS. 9-14C, the computer program can resolve disconnections as well as resolve boundaries between candidate plates included in the candidate solution. For example, as depicted in the candidate solution 820 of FIG. 8E, plate intersections are resolved and boundaries are assigned. FIG. 8F depicts an example mechanical part 822 generated from the output candidate plate set included in the candidate solution.

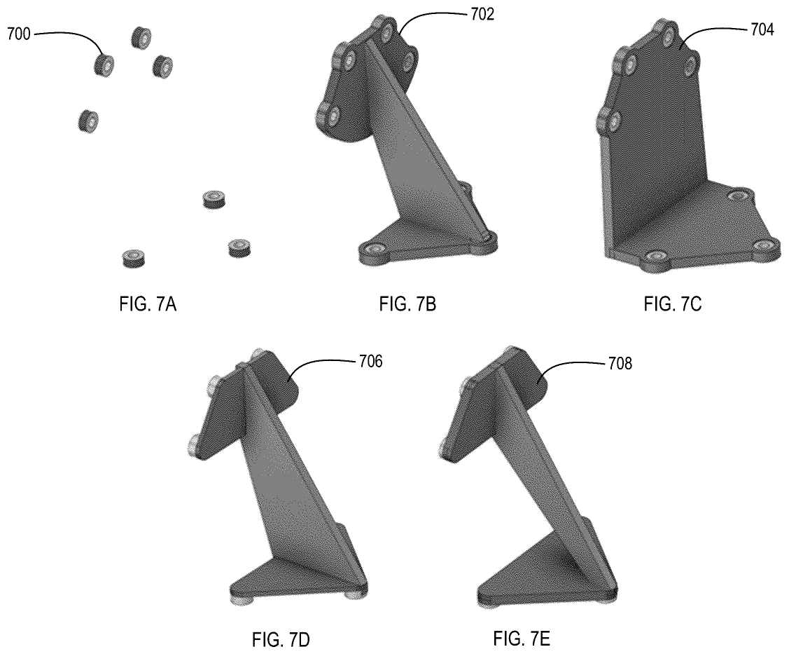

FIG. 7A depicts an example of a set of specified regions (e.g., preserve surfaces 700) in a design space from which the system generates the set of candidate solutions. FIGS. 7B, 7C, 7D, and 7E each depict examples of candidate solutions, where each candidate solution is generated using a different approach and based on the set of specified regions depicted in FIG. 7A, as described herein. For example, candidate solution 702 depicted in FIG. 7B is generated using “static approach,” candidate solution 704 depicted in FIG. 7C is generated using “dynamic approach,” candidate solution 706 depicted in FIG. 7D is generated using “simple database approach,” and candidate solution 708 depicted in FIG. 7E is generated using “database-filtered approach,” each approach of which is described in further detail herein. The shape synthesis computer program generates, as described in further detail with respect to sections entitled “single-plate driven approach” and “multi-preserve driven approach,” a set of candidate plates from the preserves defined in FIG. 7A and generates candidate solutions depicted in FIGS. 7B-7E using each of the described approaches Each depicted candidate solution includes a set of plates forming the candidate solution, where the candidate solutions form a contiguous structure and contacting the preserves.

In some implementations, the shape synthesis computer program provides, to the user, the candidate solutions for selection 190. For example, the computer program can provide, for presentation in a user interface, e.g., in UI 122 on display device 120, the candidate solutions (e.g., candidate solutions depicted in FIGS. 7B-7E) and controls 123 to select 190 one or more of the candidate solutions to select or reject one or more of the candidate solutions. For example, a 3D model produced by the processing 185 can be presented to the user 160 in UI 122.

In some implementations, the user can select from the final designs, e.g., candidate solutions produced using one or more of the approaches described herein. In some implementations, two or more 3D models resulting from the production 185 process can be presented to the user along with trade-off analysis of design weight versus cost of manufacturing, or overall strength versus difficulty of manufacturing. e.g., based on the complexity of the plate cutting operations and the number and length of the required joining operations, or any of a variety of other quantities of interest. The trade-off analysis can assist a user 160 to accept or reject one or more 3D models among the presented 3D models.

In some implementations, the shape synthesis computer program receives a user selection 190 of a candidate solution of multiple candidate solutions through a user interface. For example, the computer program can receive a user selection of a candidate solution, e.g., candidate solution depicted in FIG. 7B, of presented candidate solutions depicted in FIGS. 7B-7E in a user interface.

In some implementations, the shape synthesis computer program receives a selection of at least one candidate plate of a candidate solution through the user interface. For example, a user selection can be received during a step of the process of producing the candidate solution (e.g., during an iterative selection process). In another example, a user selection can be received after the candidate solution is produced. The selection of the at least one candidate plate can include a request to modify or reselect the selected candidate plate. In other words, to modify or update the selected candidate solution by altering at least one of the candidate plates included in the candidate solution. In response to the selection, the shape synthesis computer program can select at least two candidate plates to replace the user-selected candidate plate in the candidate solution to produce an updated candidate solution.

In some implementations, in response to receiving a selection 190 by a user of a candidate solution, the computer program provides 195 a computer model of the candidate solution, e.g., for use in manufacturing one or more physical structures corresponding to the selected one or more candidate solutions using one or more computer-controlled manufacturing systems, or for use in displaying the selected one or more candidate solutions on a display screen.

If the design is rejected, the process of FIG. 1B can return to obtain 180, e.g., by CAD program(s) 116, new design space and/or new design criteria for use in producing a new 2D or 3D model. Once a design is not rejected 190, the process of FIG. 1B can provide 195, e.g., by CAD program(s) 116, the model of the object with the synthesized shape and/or topology for use in manufacturing a physical structure. The providing 195 can involve sending or saving the 3D model to a permanent storage device for use in manufacturing the physical structure corresponding to the object using manufacturing systems. In some implementations, the providing 195 involves generating 195A, e.g., by CAD program(s) 116, toolpath specifications for computer-controlled manufacturing system(s) using the computer model, and manufacturing 195B, e.g., by CAD program(s) 116, at least a portion of the physical structure corresponding to the object with the computer-controlled manufacturing system(s) using the toolpath specifications. In some implementations, the providing 195 can include manufacturing 195B a mold for a physical structure with a manufacturing machine using the toolpath specification generated 195A, where the computer model can be a model of the mold that will be manufactured using a subtractive manufacturing process.

In some implementations, the techniques described in this document are used for shape creation generally (in 3D) where the produced shape can be used as input for processes other than iterative shape or topology optimization. The produced candidate solution can be provided 200 as input to a shape and/or topology optimization process. For example, the disconnection geometry filter described in detail below can be used to create a shape that connects a set of preserves (whether or not an obstacle body is present) that is then provided as output to the user (to the display device and/or to storage) and/or as input to further process(es). In other words, the new geometry that is produced 185 can be created for some further use, such as being input to an iterative shape and/or topology optimization loop, and/or the new geometry that is produced 185 can be a modified version of input geometry provided to an iterative shape and/or topology optimization loop, where that modification occurs in the iterative loop.

In the case where the candidate solution is provided 200 as input to shape and/or topology optimization (e.g., automated modeling or generative design), a design space for a modeled object and one or more design criteria can be obtained 180, e.g., by CAD program(s) 116, for use in producing a 2D or 3D model. The design space for a 3D modeled object is the volume inside which the part is to be designed. The design space can include a bounding volume containing an initial specification of one or more outer shapes of the 3D topology for the object. As noted above, the design space can include 3D model(s), designed in or loaded into the CAD program(s) 116, that serves as a set of input regions, e.g., preserve bodies and/or surfaces, used to specify boundary conditions for shape synthesis, e.g., B-Reps (or faces thereof) selected by a user through a user interface, such as the UI 122, to specify sub-region(s) that are preserved for use as connection point(s) with other component(s) in a larger 3D model or separate 3D model(s).

The design criteria can include geometric objectives for the shapes and geometric constraints. The geometric constraints can be provided by a user or from the CAD program(s) 116 to ensure certain characteristics of the shape are realized, e.g., to provide a shape that is easier to manufacture. For example, the geometric constraints can be defined to ensure that the generated shape can have no tiny features. The input geometry can include details for preserve regions that should be present in the design as representing interfaces to other parts of the system.

The output of the shape and/or topology optimization process, e.g., a computer model of the object, is provided 195 for use in manufacturing a physical structure and/or for use in displaying the selected one or more candidate solutions on a display screen.

In some implementations, 3D model(s) that are produced 185 or output from the shape and/or topology optimization process can be for use in additive manufacturing, subtractive manufacturing (e.g., manufactured using a 2.5-axis subtractive manufacturing process), and/or other manufacturing systems and techniques.

In some implementations, producing the candidate solutions can include a simulation-driven plate selection process, e.g., a mechanical, thermal, fluid, electromagnetic, etc. based simulations. For example, producing a candidate solution can include performing a numerical simulation on an arbitrary shape attached to the user-specified preserves, such that a field of interest (e.g., strain energy for a mechanical response) is obtained by the computer program and which can inform the placement of plates. In other words, producing the candidate solution can include selecting candidate plates that join the two or more specified regions of geometry with each other through the plates by generating a shape incorporating the two or more specified regions, and applying a numerical simulation to obtain a field of interest for the generated shape. The computer program can select at least one of the candidate plates to join the two or more specified regions in response to the field of interest.

In some implementations, a simulation-driven plate selection process can include a single simulation of the 3D starting shape (e.g., a convex hull or solid domain) to obtain a physical response in most/all of the domains. The computer program can implement a scoring component for plate selection which scores more highly candidates that occupy regions of high value in the response field (i.e., plates which occupy regions of higher strain energy can be prioritized over others which occupy low strain energy regions).

In some implementations, a simulation-driven plate selection process can include performing successive simulations as each candidate plate is considered, restricting the simulated shape to lie only on the set of already-accepted plates and currently considered candidates. In this way, the computer program can obtain more realistic simulation results.

In some implementations, a simulation-driven plate selection process can include running a simulation for each candidate plate before adding any candidate plates to the accepted set of candidate plates to produce the candidate solution. This approach can be applied in a situation in which a connected shape is formed when the candidate plate is added.

In some implementations, a simulation-driven plate selection process can include creating multiple plate configurations, then simulating each in turn and returning one or more high-quality options to the user in the user interface.

In some implementations, the shape synthesis computer program can select candidate plates having multiple layers (e.g., where the candidate plate has a thickness corresponding to two or more of a thickness of another candidate plate). The multi-layer candidate plates can be manufactured, for example, by laminating multiple 2D plates together, or by flank milling pockets or steps into a thicker piece of material. During candidate plate creation, the computer program can implement a heuristic to determine whether a plate should be multi-layer. In other words, if a plate should have a thickness equal to a thickness of at least two plates stacked together. The heuristic can include determining if the area of the plate is above a threshold to be considered for multi-layer. For example, if the top and bottom faces of the candidate plate can be extended without creating poor contact with a preserve so that the plate could be made more than double the default plate thickness, then the plate can be tagged as a multi-layer plate. The computer program can select at least two candidate plates to include in the candidate solution by selecting a first candidate plate having a default thickness and including at least two layers. Each layer of the at least two layers of the first candidate plate includes a plate profile, where the at least two layers are arranged with respect to each other to form the first candidate plate.

In some implementations, producing candidate solutions representing new geometries defined in the data structure includes implementing a single-preserve driven approach, described briefly here and in further detail below. The single-preserve driven approach includes plate configurations that are not prescribed and where preserves and candidate lists remain fixed as the computer program selects candidate plates to include in the candidate solution. Moreover, the shapes of the candidate solution can be represented in the design space as level sets. The single-preserve driven approach can further be distinguished into two sub-approaches: (i) a static single-preserve driven approach and (ii) a dynamic single-preserve driven approach. Each of these two sub-approaches are described here briefly and further described in detail below.

In some implementations, the shape synthesis computer program uses a static single-preserve driven approach including generating candidate plates from individual preserves and symmetry planes, where all preserve contacts meet a threshold quality of contact. The static single-preserve driven approach includes using a ranking of the candidate plates that is static and implements a pathfinding algorithm to resolve disconnections. The computer program identifies regions of the starting shape which are contained between the top and bottom plane of each plate. A starting shape is formed by computing a convex hull of the preserve geometries and then applying the disconnection filter to ensure all preserves are contacted. At the end of the single-preserve driven approach, a profile geometry assigned to each plate is extracted from the convex hull by flattening the portion of the 3D starting shape which lies within each candidate plate's domain. Further details of the static single-preserve driven approach are described below.

In some implementations, the shape synthesis computer program uses a dynamic single-preserve driven approach including classifying individual preserves and using the classified individual preserves to generate candidate plates, where only candidate plates meeting a defined “high quality” of contact are selectable for inclusion in the candidate solution. The dynamic single-preserve driven approach includes using a ranking of the candidate plates that is dynamic and implements additional passes of the selection process to resolve disconnections. Initially, the dynamic single-preserve driven approach retains only the bounding box of the design, filling the bounding box with material. This “solid” starting shape definition is retained throughout the plate selection process, until a new convex hull starting shape is computed in the postprocessing stage. At times, the dynamic single-preserve driven approach can result in higher quality contact to the preserves and can result in improved handling of disconnections. Additionally, the dynamic single-preserve driven approach can allow for additional (e.g., redundant) plates to be added to the candidate solution to yield improvement of the overall solution quality.

In some implementations, producing candidate solutions representing new geometries defined in the data structure includes implementing a multi-preserve driven approach, described briefly here and in further detail below. The multi-preserve driven approach includes generating candidate plates where each of the candidate plates conforms to a specified database of acceptable configurations, and where a list including preserves and candidate plates is updated after each selection of a candidate plate to include into the candidate solution. Moreover, the shapes of the candidate solution are represented in the design space as meshes and disconnections are resolved by incorporating any obstacles into a generated convex hull. The multi-preserve driven approach can further be distinguished into two sub-approaches: (i) simple database multi-preserve driven approach, and (ii) database-filtered multi-preserve driven approach. As opposed to the single-preserve driven approach, implementing the multi-preserve driven approach does not include discretizing the model geometry onto a voxel grid but instead performing the computations using surface meshes (e.g., triangle mesh).

In some implementations, the shape synthesis computer program uses a simple database multi-preserve driven approach including generating candidate plates by comparing groupings of the preserves to a known database of acceptable configurations. The simple database multi-preserve driven approach further includes using a ranking of the candidate plates that is prescribed by the database of acceptable configurations. The candidate plate profiles are created using a 2D convex hull of the preserves in the grouping. During preprocessing, the simple database multi-preserve approach classifies each preserve based on its shape, though with a different approach to the dynamic single-preserve driven approach.

In some implementations, the shape synthesis computer program uses a database-filtered multi-preserve driven approach including generating candidate plates from individual preserves or groupings of preserves, where the generated candidate plates are filtered against a database of acceptable configurations.

In some implementations, producing candidate solutions representing new geometries defined in the data structure includes ranking, by the shape synthesis computer program, candidate plates to form the candidate solution.

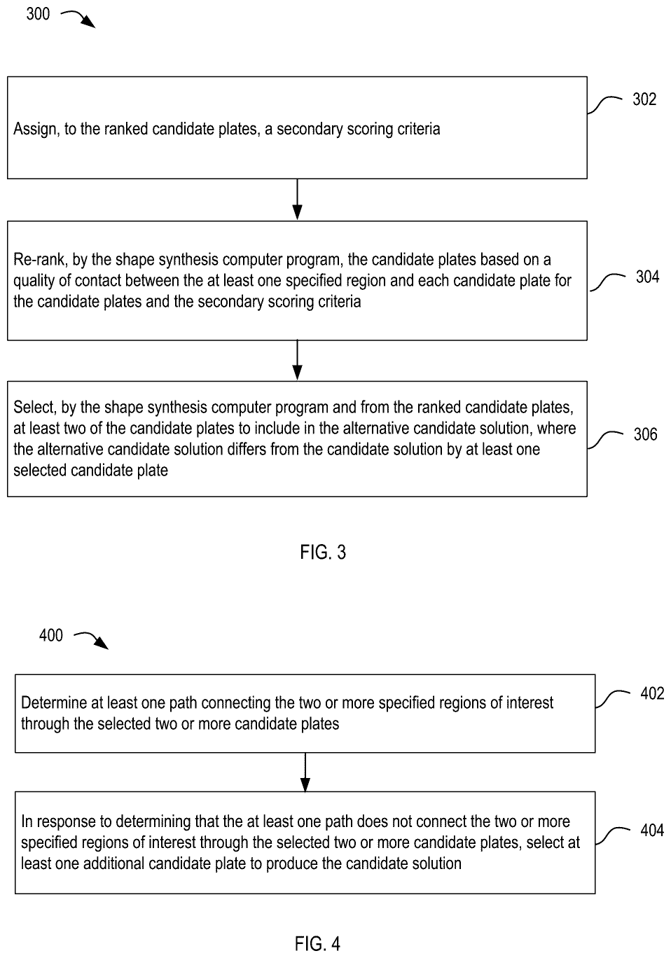

In some implementations, the shape synthesis computer program can provide multiple configurations of candidate plates to a user in a user interface, where the multiple configurations may have at least a threshold divergence from each other to produce a set of alternative candidate solutions. In this way, the computer program may generate a set of candidate solutions that provide variations (e.g., different candidate plate selections) for resolving the set of preserves. Using the methods described herein related to the four different approaches referred to as (A) “static single plate-driven approach,” (i.e., “static approach”) (B) “dynamic single plate-driven approach,” (i.e., “dynamic approach”) (C) “simple database multi-preserve driven approach,” (i.e., “simple database approach”) and (D) “database-filtered multi-preserve driven approach,” (i.e., database-filtered approach”), the computer program may additionally generate a set of additional candidate plates to produce the set of alternative candidate solutions. FIG. 3 is a flow diagram of an example of a process 300 for producing an alternative candidate solution. The computer program assigns 302 a secondary scoring criteria to the ranked candidate plates. For example, the computer program can adjust relative weights of some of the scoring parameters (e.g., aspect ratio, plate source, symmetry, plate intersection, etc.) that were previously used to initially rank the set of candidate plates. In another example, the computer program can add an additional scoring component, e.g., a penalty for candidate plates that have a threshold similarity to candidate plates that were selected to produce one of the initial set of candidate solutions.

The computer program re-ranks 304 the candidate plates using the quality of contact between the preserves and each candidate plate for the set of candidate plates as well as using the secondary scoring criteria. The computer program selects 306, from the ranked candidate plates, at least two of the candidate plates to include in the alternative candidate solution. The alternative candidate solution differs from the candidate solution by at least one selected candidate plate.

In some implementations, each additional plate set can be compared to the first plate set used to produce a candidate solution where configurations which are low quality can be filtered out, for example, using an overall system score, based on a threshold similarity to the first candidate plate set, or based on a threshold similarity to another alternative candidate plate set. The computer program can provide the accepted alternative candidate plate sets in the user interface along with the first generated candidate plate set.

In some implementations, producing candidate solutions representing new geometries defined in the data structure includes disconnection filtering of one or more of the candidate solutions. Generally, the computer program may implement disconnection filtering to resolve any discontinuities between the selected candidate plates forming the candidate solution, to ensure that the initial selected set of plates are connected (i.e., that the plates form a path between every pair of preserves after any obstacles are removed). The disconnection filtering process can be used to refine the selected set of candidate plates to create a connected set of candidate plates and, optionally, add additional candidate plates to form the solution if they are determined to improve a quality of the candidate solution. FIG. 4 is a flow diagram of an example of a process 400 for disconnection filtering. The computer program determines 402 at least one path connecting the preserves through the selected candidate plates of the candidate solution. In response to determining that the path does not connect the preserves through the selected candidate plates, the computer program selects 404 at least one additional candidate plate to produce the candidate solution.

In some implementations, the computer program resolves disconnections using pathfinding, e.g., in the “static approach.” FIGS. 9A, 9B, 9C, 9D and FIGS. 9E, 9F, 9G, and 9H depict examples of processes for resolving disconnections. In general, the computer program identifies regions of the starting shape which are contained between the top and bottom plane of each candidate plate. A cost grid is set to apply a first penalty (e.g., a small) to paths that leave the initial starting shape and apply a second (e.g., large) penalty to paths that leave the current plate set. The computer program runs the pathfinding algorithm to find paths between preserves in the domain, and “problem segments” are identified where the path leaves the intersection of the plate volumes and the starting shape. Depending on where the path 922 travels, the computer program can resolve the disconnection by adding material to the starting shape or by adding additional candidate plates to the candidate solution.

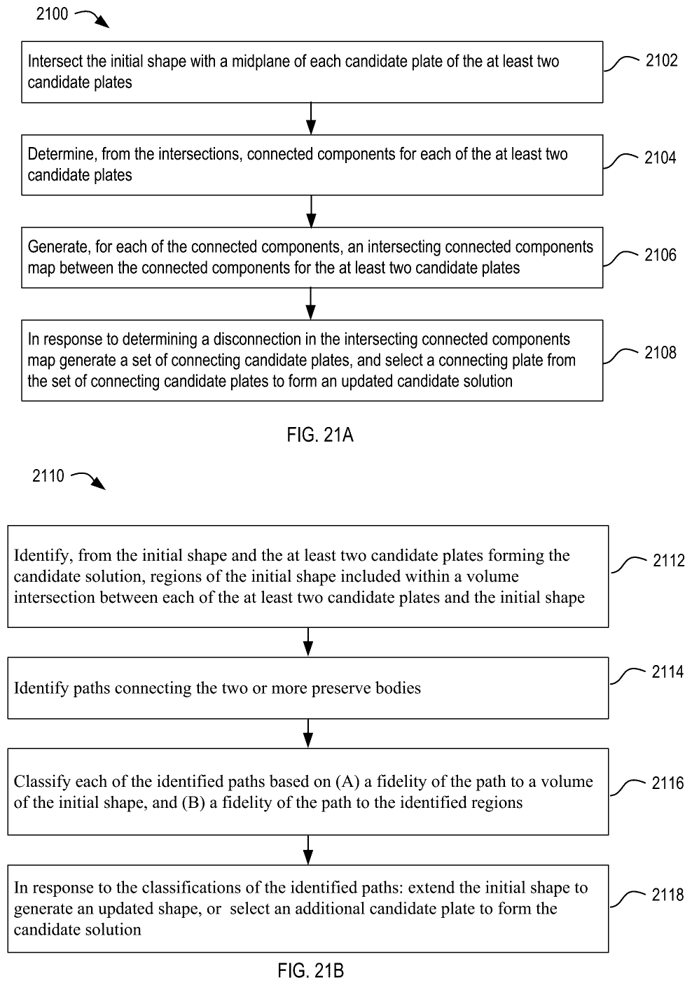

In some implementations, a problem segment leaves the candidate plate set entirely where there is no available path to connect the preserves that remains inside the set of candidate plates. In this case, the computer program adds an additional candidate plate to the candidate plate set to ensure the final design is connected. In some implementations, the computer program uses pathfinding to resolve disconnections, e.g., in the “static approach,” and as described with reference to the flow diagram of FIG. 21B. The computer program identifies 2112, from the initial shape and the at least two candidate plates forming the candidate solution, regions of the initial shape included within a volume intersection between each of the at least two candidate plates and the initial shape.

FIG. 9A depicts views 900 and 910 of an example design space including an obstacle 902, preserves 904, 906, and 908, and starting shape (e.g., convex hull) 912. A pathfinding algorithm is used to determine whether the candidate plate set arranged with respect to a set of preserves (e.g., preserves 904, 906, 908) is connected and to heuristically (e.g., based on one or more disconnection filtering algorithms) add additional plates to form a connected set.

Referring back to FIG. 21B, the computer program identifies 2114 paths connecting the two or more preserves and classifies 2116 each of the identified paths based on (A) a fidelity of the path to a volume of the initial shape, and (B) a fidelity of the path to the identified regions. In other words, pathfinding is used to find paths between preserves in the design space, and “problem segments” are identified where the path leaves the intersection of the volumes of the plate(s) and the starting shape (i.e., does not remain within the defined boundaries of the problem).

FIG. 9B depicts views 920 and 930 of a path 922 determined by the path finding algorithm(s) between the set of candidate plates 924, 926, and 928 selected for inclusion in the candidate solution. FIG. 9C depicts a view 932 of the candidate solution and path 922 where a plane 934 containing the start, end, and middle points of the problematic segment 938 of the path 922 is identified. Referring back to FIG. 21B, in response to the classifications of the identified paths, the computer program extends 2118 the initial shape to generate an updated shape or selects an additional candidate plate to form the candidate solution. For example, if a problem segment enters the mildly penalized region contained in the plate set but leaving the starting shape, the computer program can add material to the starting shape to ensure the preserves are connected in the output shape. In another example, if a problem segment leaves the plate set entirely, the computer program can apply a higher penalty and potentially determine that there is no available path to connect the preserves that remains inside the plates. In this case, the computer program can add a plate to the plate set to ensure the final design is connected. FIG. 9D depicts a view 936 of the candidate solution where an additional candidate plate 940 is included.

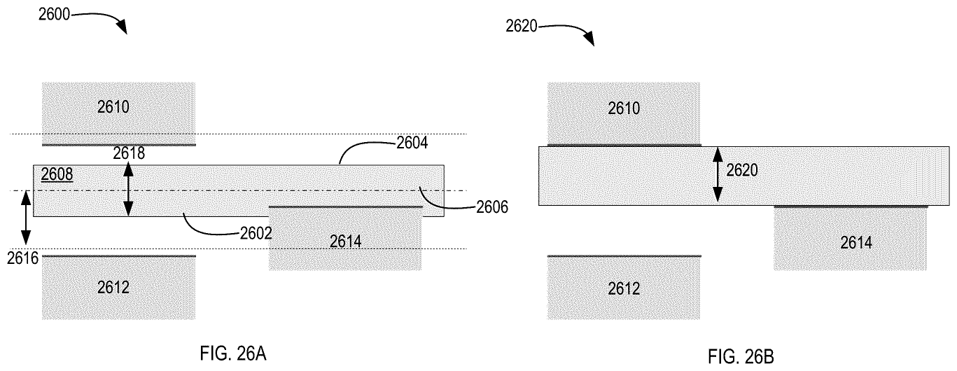

Determining the additional candidate plate to add to the candidate solution can include, for example, the computer program can compute a new plate normal from the cross product of the normal of the candidate plates the problem segment starts on and ends on. The midplane origin of the new candidate plate can be the middle point in the problem segment, or an average of the points along the problem segment. In another example, the computer program can create a new plate by selecting the midplane as the plane that contains the start, middle, and end points of the problem segment (e.g., as depicted in FIG. 9C). In another example, the computer program can create a new candidate plate by selecting a candidate plate that is perpendicular to an adjacent plate and passing through two points on the problem segment of the path. The new plate's thickness can be set at the default or can be determined as described with reference to FIGS. 26A-26B. In some instances, the computer program identifies more than one problem segment, such that the computer program may repeat the above procedure and to identify other problem segments and correct them.

In some implementations, a problem segment enters the region contained in the plate set but leaving the starting shape. In such cases, the computer program can add material to the starting shape to ensure the preserves are connected in the output shape. For example, the computer program can generate a ball of fixed size at each point along the identified problem segment of the path of the pathfinding result and combine the balls with the original starting shape to create a new starting shape that will allow the path to remain inside the part. FIGS. 9E-9H depict an example of a process for resolving disconnections by adding additional material to the candidate solution. FIG. 9E depicts various views 950, 952, 954 of a starting shape 950 including preserves 958, 960, 962 and obstacle 964. FIG. 9F depicts various views 966, 968, 970 of a candidate solution including candidate plates 972, 974, 976 and a path 978 where a portion of the path that deviates from (i.e., leaves the) convex hull starting shape due to obstacle 964. FIG. 9G depicts various views 980, 982, 984 highlighting the portion 986 of the path 978 that deviates from the convex hull starting shape due to the obstacle 964. FIG. 9H depicts various views 988, 990, 992 of the updated starting shape after adding material 994 along the deviating segment of the path.

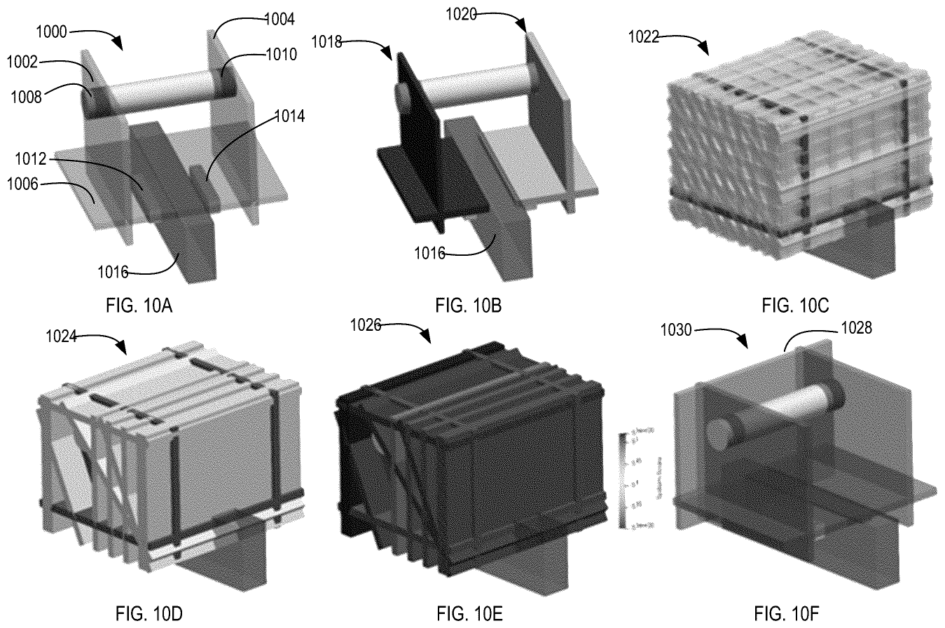

In some implementations, the computer program resolves disconnections using connected components, e.g., in the “dynamic approach.” FIGS. 10A, 10B, 10C, 10D, 10E, and 10F depict another example of a process for resolving disconnections. The computer program evaluates a 2D profile for each candidate plate included in the candidate solution by slicing the starting shape with the candidate plate's midplane and uses it to find connected regions of geometry (“connected components”). At times, candidate plates may have one connected component. At times, candidate plates may have two or more if obstacles divide the plate into pieces. Where plates intersect, the computer program links the connected component(s) on one candidate plate with those on the intersecting candidate plate, so as to build a global connected components map for the design. In the case that the global connected components map includes only one component which contains preserves, the design is connected and no further action is necessary. In the case that more than one component contacting a preserve is detected, a disconnection is present, and the computer program may select to add a “connecting plate” to the design.

To create connecting plates, the computer program adjusts scoring and ranking of candidate plates to generate and select candidates to bias the selection of candidate plates toward the connectivity of the candidate solution. For example, an updated set of candidate plates including preserve-driven candidate plates with new candidates derived from the extrude preserves, bounding box, symmetry planes, the convex hull, etc., are generated to create an updated set of possibilities. Each of the updated set of candidate plates is scored using an updated scoring method, for example, a new scoring mechanism which evaluates the connectivity and quality of a set of candidate plates. The computer program assigns a system score to each candidate connecting plate by scoring the accepted plates and the candidate plate as a whole system. Details of the metrics of the system score are described further below with reference to Table (1). FIG. 10A depicts an example candidate solution 1000 including candidate plates 1002, 1004, 1006 selected for inclusion in the candidate solution to connect preserves 1008, 1010, 1012, and 1014. FIG. 10B depicts two separate regions 1018 and 1020 of the candidate solution, indicative of a disconnection caused by obstacle 1016 for which a connecting plate is required. FIG. 10C depicts a set of candidate connecting plates 1022 generated using the connecting plate algorithm. FIG. 10D highlights a subset of candidate plates 1024 which resolve the disconnection by reducing the candidate solution to a single connected component. FIG. 10E depicts a scoring 1026 of each of the candidate connecting plates, and FIG. 10F depicts a highest performing candidate connecting plate 1028 for inclusion in the final candidate solution 1030.

In some implementations, the computer program implements the connected components methods described with respect to FIGS. 10A-10E in instances where no disconnection is present in the candidate solution. In such cases, the computer program uses the connected components map to evaluate an overall system score for the candidate solution to determine whether an addition of an additional candidate plate results in at least a threshold improvement to the system score such that the computer program will add the additional candidate plate to the candidate solution.

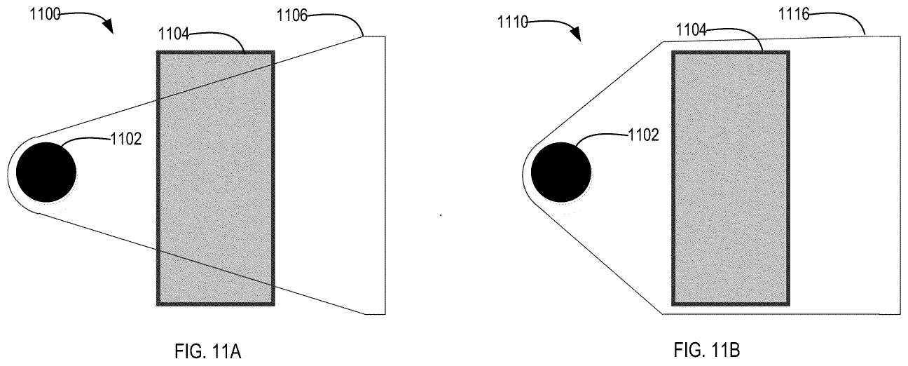

In some implementations, the computer program resolves disconnections based on a convex hull of the candidate plates included in the candidate solution, e.g., in the “simple database” and “database filtered” approaches. FIGS. 11A-11B depict another example of a process for resolving disconnections. FIG. 11A depicts an example 1100 of a candidate plate profile 1106 including preserve 1102. After selecting an initial plate profile 1106 including preserve 1102, the computer program can use a connected components algorithm to check if all entities in the candidate plate's grouping are connected, e.g., in view of an obstacle 1104. If they are not, e.g., the plate's profile 1106 is broken into two or more disconnected components as depicted in FIG. 11A, the computer program can re-run a convex hull algorithm to produce an updated plate profile 1116 including an offset of the obstacle intersections of the obstacle 1104 with the midplane in the computation, e.g., as depicted in the example 1110 of FIG. 11B. At times, adding an obstacle to the convex hull does not resolve the disconnection. In such cases, the candidate plate cannot avoid a disconnection and the computer program can reject the candidate plate and continue with the next highest ranking candidate plate.

In some implementations, the computer program can filter candidate plates that are determined to not improve the connectivity of the candidate solution. The computer program can evaluate a number of connected components, as described above, at each point when a new candidate plate is added to the candidate solution and determine if the number of connected components containing preserves is not reduced by the addition of the candidate plate, then the candidate plate is not added and a next highest ranked candidate plate is evaluated. Table (1) presents components of a system score for a set of candidate plates included in a candidate solution with a new candidate plate included in the candidate solution.

TABLE 1

| | NAME | DESCRIPTION | PURPOSE |
|---|---|---|---|
| All | Average Plate | The average of the Total Score | Reward intrinsically |
| Plates | Total Score | computed for each candidate plate | valuable plates |
| | | using a heuristic | |
| | Intersection | Measure the total length of plate- | Encourage more |
| | Length | plate intersections inside the starting | intersections for a more |
| | | shape and divide by the domain | connected design |
| | | diagonal and the plate count | |
| | Symmetry | Pairs of symmetric plates are | Encourage symmetric |
| | Bonus | rewarded with an extra bonus | designs |
| | Preserve | Compute the mean distance | Encourage plates which |
| | Proximity | between each plate and every | are generally closer to |
| | | preserve, penalizing larger values | the preserves |
| New | Perpendicular | Provide a bonus if there are exactly | Encourage mutually |
| Plate | Bonus | two accepted plates and the new | perpendicular plate sets |
| Only | | plate is perpendicular to both | |
| | Non-Preserve | Count the number of connected | Discourage blobs of |
| | Connected | components which do not contain a | geometry floating in |
| | Components | preserve before and after adding the | space that aren't |
| | | new plate, and penalize | attached to the model |
| | | more/reward fewer | |
| | Useless Extra | If the new plate contains no | Avoid “useless” plates |
| | Plate Penalty | components associated with a | that don't touch |
| | | preserve, penalize it | preserves |
| | Bonus for Fixing | If a plate comes between another | Reduce bad contact |
| | Bad | plate and a preserve for which that | between plates and |
| | Intersections | other plate had an Unacceptable | preserves by encouraging |
| | | intersection, give a bonus | plates that may “split” |
| | | | the preserve and |
| | | | offending plate apart |
| | Self-symmetry | Add a bonus if the new plate is self- | Encourage symmetric |
| | Bonus | symmetric (i.e., on or perpendicular | plate sets |
| | | to a symmetry plane) | |
| | Overlap Penalty | Penalize if the new plate has overlap | Discourage visually poor- |
| | | with an existing plate less than a | quality plate sets |
| | | threshold | |

In some implementations, the computer program determines whether to add an additional plate to the candidate plates included in the candidate solution. The computer can determine to add the additional candidate plate if including the additional candidate plate results in at least a threshold improvement of a calculated system score for the candidate solution. In some implementations, this process is included in one or more of the different approaches described herein, e.g., in the “dynamic approach.”

FIG. 22 is a flow diagram of an example process 2200 for adding an additional connecting plate to improve a solution score. The computer program determines 2202, for the at least two candidate plates and the additional connecting plate forming the candidate solution, a system score. The computer program ranks 2204 each of the remaining set of connecting candidate plates based on an increase to the system score from including the connecting candidate plate in the candidate solution. For example, if a top-ranked candidate plate improves the system score by a threshold amount (e.g., by 5%, 10%, 15%, etc.), the computer program adds the top-ranked candidate plate to the candidate solution. The computer program selects 2206 for inclusion in the candidate solution, an additional connecting plate using the ranking of the remaining set of connecting candidate plates.

The computer program can calculate the system score of the set of candidate plates included in the candidate solution after all connecting plates have been added, then re-score the remaining connecting candidate plates, ranking them according to the amount of improvement each provides to the system score. If the top-ranked candidate plate improves the system score by a threshold amount (e.g., by at least 5%, 10%, 15%, etc.), the additional candidate plate is added to the candidate solution.

In some implementations, producing candidate solutions representing new geometries defined in the data structure includes resolving intersections between candidate plates forming a candidate solution. For example, to produce usable, high-quality manufacturable designs, two plates can be prevented from overlapping. Thus, when a candidate plate set includes two plates which intersect in the design domain, the computer program resolves the intersection such that only one plate occupies the space. It may also be desirable to “bound” plates such that the candidate plates do not extend beyond an intersecting plate unless the geometric context requires it (e.g., to prevent geometry “seeping through” what should otherwise be a clean junction between plates). In cases where the output candidate solution is used for optimization (e.g., shape and/or topology optimization), it may be important to keep these types of artifacts from appearing by explicitly bounding the plate.

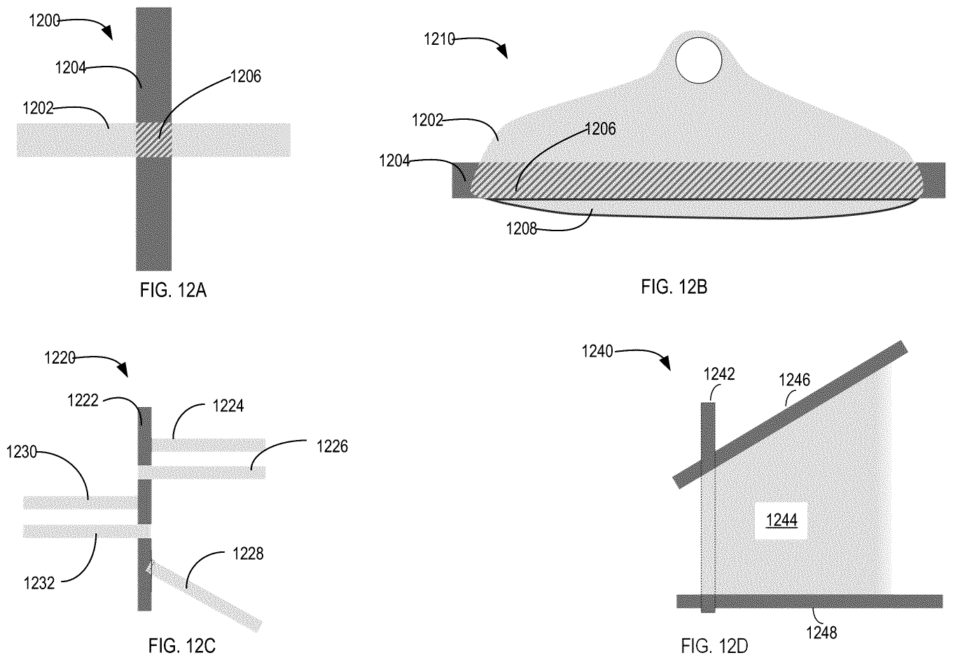

As depicted in FIGS. 12A-12D, in instances where a candidate solution includes two candidate plates that intersect in the design domain, the computer program can resolve the intersection such that only one plate occupies the space. For example, FIG. 12A depicts edge on views 1200 of candidate plates 1202 and 1204 intersecting at an intersection region 1206 occupied by both candidate plates. FIG. 12B depicts an edge on view of candidate plate 1204 and a profile view of candidate plate 1202, where a portion 1208 of candidate plate 1202 extends from a surface of the intersecting plate 1204. The portion 1208 extending from 1202 can be undesirable from a manufacturing perspective because it does not contact another plate or preserve region.

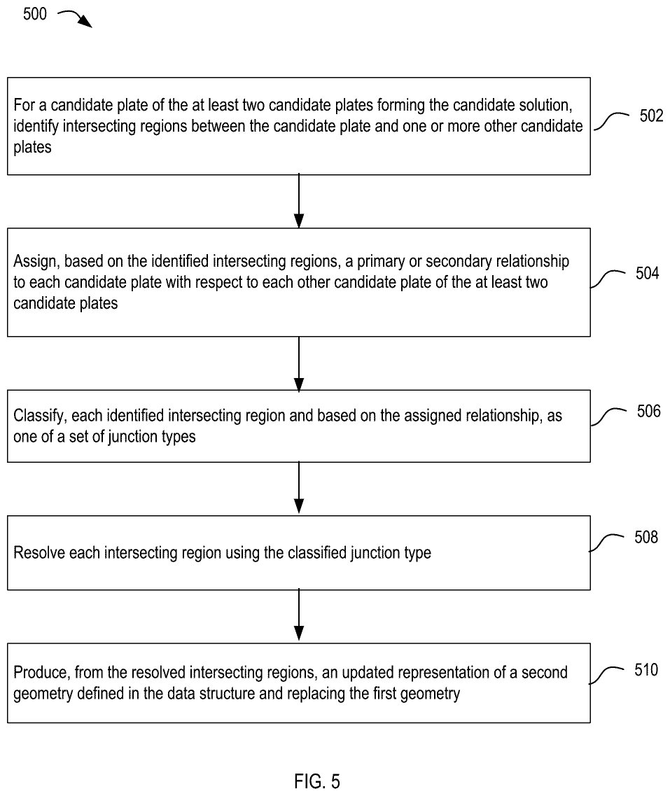

In some implementations, the computer program can “bound” candidate plates of the candidate solution such that candidate plates included in the candidate solution do not extend beyond an intersecting plate unless the geometric context requires it. Performing a bounding operation can prevent a geometry “seeping through” what should otherwise be a clean junction between plates, e.g., as depicted in FIG. 12B, where a manufacturing process would restrict two plates from overlapping. In other words, the computer program can resolve any intersections between candidate plates of a candidate solution to produce a higher-quality manufacturable part. FIG. 5 is a flow diagram of an example 500 for performing a split and bound process. For a candidate plate of the at least two candidate plates forming the candidate solution, the computer program identifies 502 intersecting regions between the candidate plate and one or more other candidate plates. In some implementations, the computer program can implement a two-step approach for a plate intersection algorithm applied to each candidate plate selected for inclusion in the candidate solution.

The computer program assigns 504, based on the identified intersecting regions, a primary (i.e., owner/bounding) or secondary (i.e., child/twin) relationship to each candidate plate with respect to each other candidate plate of the at least two candidate plates. In other words, the computer program evaluates each intersection between two candidate plates in the solution to define a relationship between the two candidate plates. For example, for two plates forming an intersection, the computer program can designate each plate's relationship to the other plate by assigning the first plate to have a primary relationship (e.g., bounding) and assigning the second plate to have a secondary relationship (e.g., child). Each bounding relationship defines a unique plane that bounds the geometry in the candidate plate, where the planes are defined as “bounding planes”. The assigned relationship can include (i) zero or more “bounding plates” which limit a candidate plate to one side of an intersecting plane (i.e., a top or bottom face of another candidate plate), (ii) zero or more “child plates” which are other candidate plates that end on a surface of the candidate plate, and (iii) zero or more “twin plates” defined as clones of the input candidate plate and having different bounding and child relationships, and different profiles (e.g., because the bounding planes define a region for each plate in which the 2D plate profile may exist).

As used in this specification “bounding” plates limit the area of the candidate plate to a subset of the whole domain by requiring the candidate plate stay on one side of the intersection of the bounding plate with a bounding plane derived from another plate. The “bounding” relationship carries with it metadata, e.g., as depicted in FIG. 12C. FIGS. 12C and 12D depict examples 1220 and 1240 of relationships between a bounding plate and various other intersecting plates with the bounding plate. FIG. 12C depicts a bounding plate 1222 and multiple intersecting plates 1224, 1226, 1228, 1230, and 1232, where each of the intersecting plates has an angle of intersection with respect to plate 1222. As depicted, intersecting plates 1224, 1226, 1230, 1232 each have an angle of intersection that is orthogonal with respect to bounding plate 1222. In the instance of a bounding plate and an intersecting plate where the angle of intersection is not orthogonal, the angle of overlap is used to ensure that the intersecting plate penetrates a threshold amount into the bounding plate (e.g., to avoid cracks in the model), e.g., as depicted by candidate plate 1228 intersecting with candidate plate 1222 in FIG. 12C. In each instance of an intersection between two plates, one plate is defined as an “owner” of the intersection, where each other candidate plate is defined as a “child” plate.

For example, the computer program determines which side of the bounding plate the intersecting plate must remain on (positive or negative), and which face of the bounding plate can be used for the bounding. If an intersecting plate has a bounding relationship where the bound side and bounding plate face are not the same (i.e., intersecting plates 1226 and 1232), that plate occupies the area of intersection between the two plates and is assigned to “own” the intersecting region. If an intersecting plate and its bounding plate are not orthogonal, the computer program adds an “angle overlap” that ensures the intersecting plate penetrates far enough into the bounding plate to avoid cracks in the model (i.e., it creates the small, dashed region shown for intersecting plate 1228). An example of a top view of a candidate plate 1244 which has been bounded by three other plates 1242, 1246, 1248 and which owns one of the intersecting regions is shown in FIG. 12D. Each bounding relationship defines a unique plane that bounds the geometry in the plate, i.e., these planes are called “bounding planes”.

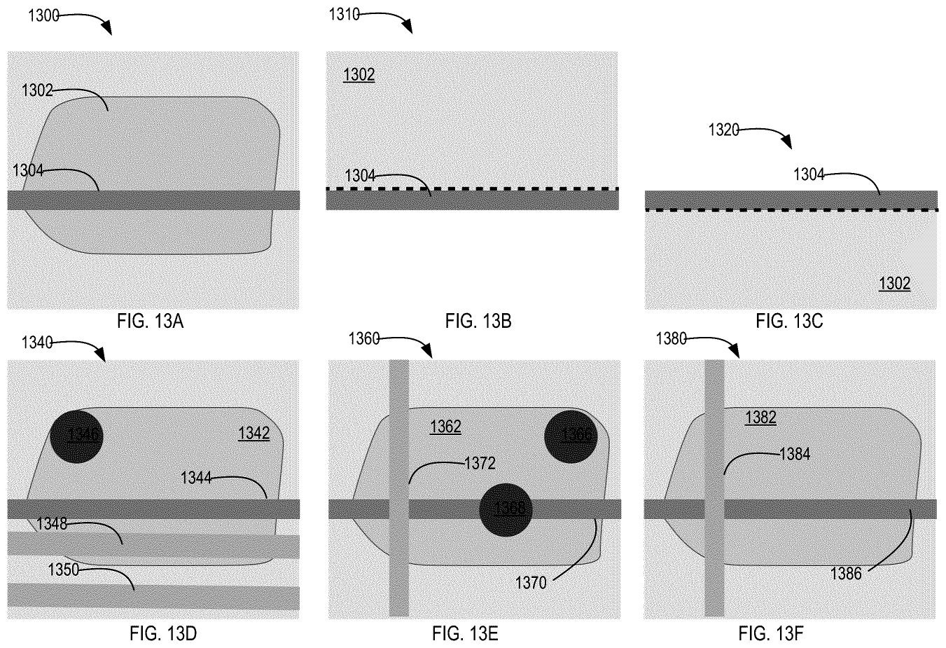

To establish bounds for the candidate plates, the computer program assigns initial bounding and child relationships to each plate by examining the other geometry in the problem each plate encounters. Bounding relationships can be defined for two plates that intersect inside the design domain. For each pair of two intersecting plates in the design domain, the computer program can evaluate the intersecting plates by assigning the first plate to be a “Target” and the second plate to be the “Considered. The Target plate is the plate to which the computer program adds relationship(s). The computer program successively sets each other plate in the set of candidate plates as the Considered plate to which the computer program will evaluate the possibility of adding a bounding relationship with the Target plate. The computer program can further require the intersection between Target and Considered to be “material”, i.e., the intersection region contains at least some of the starting shape (e.g., in the single-plate driven approaches) or is contained in either plates' profile (e.g., in the multi-preserve driven approaches). FIGS. 13A, 13B, 13C, 13D, 13E, and 13F depict an example of bounding a set of candidate plates. FIG. 13A depicts an example 1300 including a candidate plate, e.g., “target plate,” 1302 which lies in the plane of the image, and a second candidate plate, e.g., “considered plate,” 1304 that is potentially intersecting perpendicular to the plane of the target candidate plate. FIGS. 13B and 13C depict examples 1310 and 1320 of two possible bounding relationships for the intersecting plate with the target candidate plate, e.g., FIG. 13B depicts a bounding below the considered plate 1304 and FIG. 13C depicts a bounding above the considered plate 1304. FIGS. 13D-13F depicts different examples 1340, 1360, 1380 of configurations of the design including additional features that can inform how the computer program defines the bounding relationship between the target candidate plate and the intersecting candidate plate.

In some implementations, the computer program can consider the presence of additional parallel candidate plates and a preserve (e.g., as depicted in FIG. 13D). The computer program determines bounding by considering other preserves and intersection regions which intersect the target plate. An intersecting preserve (e.g., preserve 1346 in FIG. 13D) indicates that the computer program should not trim away the top side of the target plate 1342 to maintain the desirable connection with the preserve. Similarly, materially intersecting plate 1348 (i.e., a plate which intersects plate 1342 inside its plate profile but is not considered below the target plate 1342) indicates that the computer program should not trim away the bottom side of the target plate 1342, so that intersecting plate 1348 can contact it. The target plate 1342 in FIG. 13D should keep material on both sides of the considered plate 1344 so no bounding relationship is formed. Intersecting plate 1350 contacts the target plate 1342 outside of the plate profile so as to form a non-material intersection and is therefore not considered by the computer program in the bounds check.

In some implementations, the computer program can consider the presence of an orthogonal additional candidate plates and preserves (e.g., as depicted in FIG. 13E). In FIG. 13E, the intersecting plate 1372 forms a material connection on both sides of the considered plate 1370, so it is not considered by the computer program in the bounding check. Preserve 1366 ensures the upper portion of the target plate 1362 should be retained. Preserve 1368 is present on both upper and lower portions of the considered plate 1370 and creates an ambiguous case. Depending on the application, it may be desirable to not bound the target plate 1362 (e.g., so as to ensure full contact with Preserve 2) or it may be desirable to bound the target plate 1362 above plate 1370 (e.g., ensuring that no extra geometry extends needlessly since preserve 1368 is already contacted by target plate 1362 on the top half).

In some implementations, the computer program can consider the presence of an additional orthogonal candidate plate (e.g., as depicted in FIG. 13F). In some cases, there is no intersecting feature to inform the bounding decision. For example, as depicted in the example 1380 of FIG. 13F, where the intersecting plate 1384 is ignored by the computer program because it has a material intersection with target plate 1382 on both sides). In this case, the computer program can assess how much of the target plate 1382 profile area is on each side of the considered plate 1386. For example, if the amount is roughly even (e.g., less than 15% difference), no bounding is applied, otherwise the side with the greater area of starting shape is selected to be retained. In all three of the above examples, if the target plate 1382 intersects the considered plate 1386 materially but is not bound by it, the considered plate 1386 is added to the list of children for the target plate 1382.

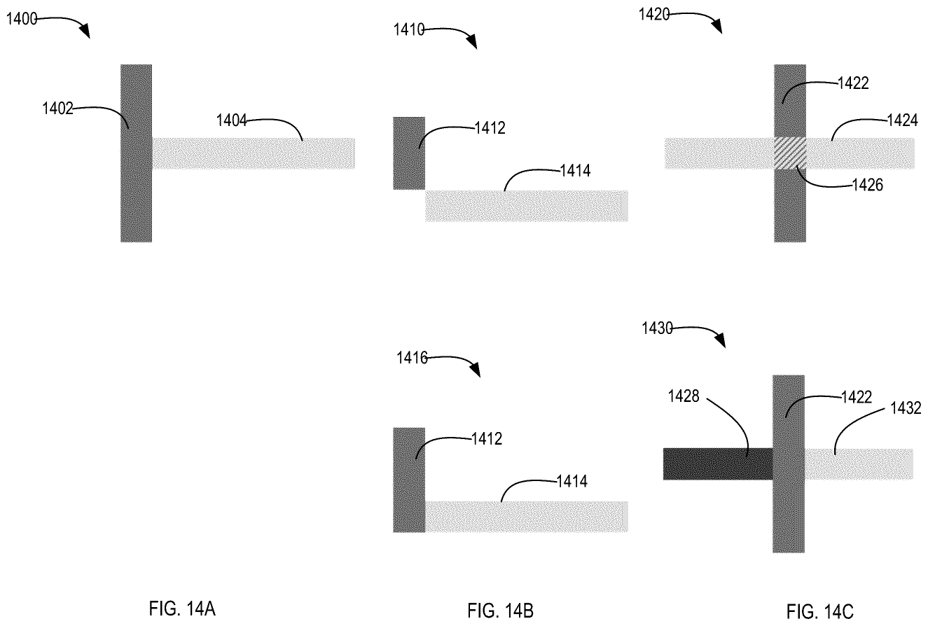

The computer program classifies 506 each identified intersecting region and based on the assigned relationship (e.g., as bounding/child relationships) as one of a set of junction types. FIGS. 14A, 14B, and 14C depict examples of different classifications of plate intersections. Classifying each identified intersecting region as one of the set of junction types can include classifying the identified intersecting region as one of a “T” junction includes a first plate bounded by a second plate where the second plate is not bounded by the first plate (e.g., as depicted in FIG. 14A), an “L” junction where two plates are mutually bounded by each other (e.g., as depicted in FIG. 14B), and an “X” junction where two plates intersect without forming a bounding relationship (e.g., as depicted in FIG. 14C).

Referring back to FIG. 5, the computer program resolves 508 each intersecting region using the classified junction type. In other words, the computer program can use the classification of each intersection and assign an “ownership” of each intersecting region to one of the participating candidate plates in order to resolve the intersecting region. As depicted in example 1400 of FIG. 14A, if two candidate plates 1402 and 404 form a “T” junction, such that the junction does not require resolution, where the “owner” plate 1402 and “child” plate 1404 are maintained from the original assignment. As depicted in examples 1410 and 1416 of FIG. 14B, two candidate plates 1412 and 1414 depicted in example 1410 form an “L” junction such that the computer program assigns ownership, as depicted in example 1416, of “owner” plate 1412 and “child” plate 1414 of the “L” junction based on the area of each candidate plate profile. Whichever plate in the “L” junction has the larger profile area is assigned as the owner, and the non-owning plate is added to the child list of the owning plate. As depicted in examples 1420 and 1430 of FIG. 14C, two candidate plates 1422 and 1424 with intersecting region 1426 form an “X” junction, such that the computer program selects one plate 1422 to own the intersection and splits the other plate in two child plates 1428 and 1432 (i.e., one for each side of the owning plate). The owning plate can be selected based on having a larger plate profile area. The computer program then clones the non-owning plate, where the original is assigned to be upper bounded by the owning plate and the clone is lower bounded (but otherwise identical). The newly cloned plate is added to the child list of the owning plate, and the two nearly identical plates are each related to the other with the twin relationship.

The computer program produces 510, from the resolved intersecting regions, an updated representation of a second geometry defined in the data structure and replacing the first geometry. The output of the process 500 can be provided 195 for use in manufacturing a physical structure, as described with reference to FIG. 1B.

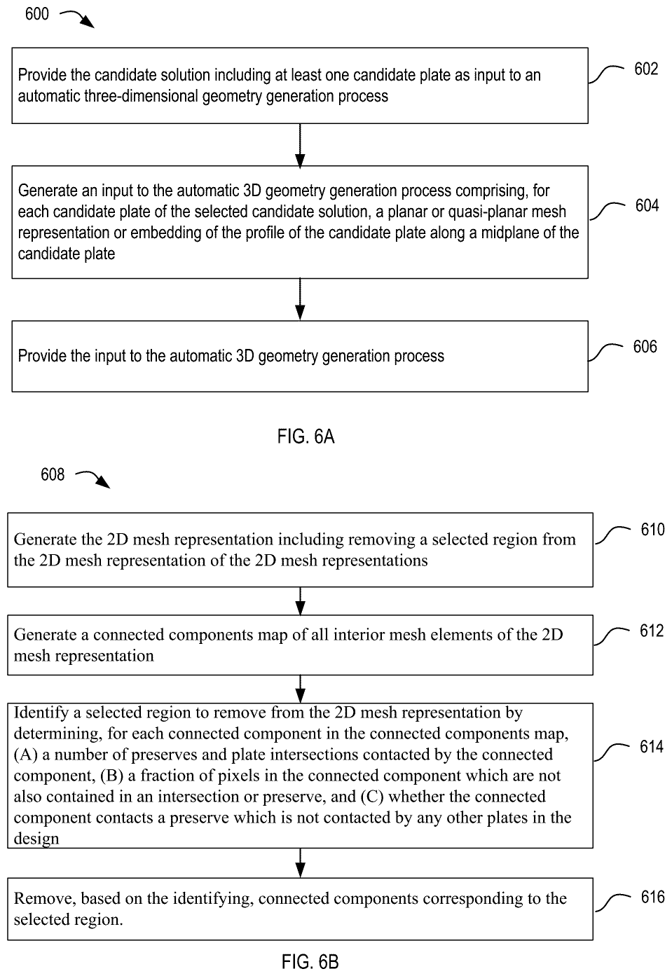

In some implementations, a selected candidate solution is processed prior to providing the candidate solution as input to a shape and/or topology optimization process. The computer program can include an add-on feature to prepare a candidate solution generated by the processes described herein as an input to a shape and/or topology optimization process. FIG. 6A is a flow diagram of an example process 600 for processing a candidate solution for input to a shape and/or topology optimization process. The computer program provides 602 the candidate solution including at least one candidate plate as input to an automatic three-dimensional geometry generation process, where the computer program generates 604 input to the automatic 3D geometry generation process including, for each candidate plate of the at one candidate plate of the selected candidate solution, a planar or quasi-planar (e.g., 2.5D) mesh representation or embedding of the profile of the candidate plate along a midplane of the candidate plate. Generating the input for each of the at least two candidate plates can include generating a 2D mesh representation including (A) a 2D level set representation, (B) a 2D surface mesh, or (C) a 2D grid includes a discrete representation of the candidate plate.

In some implementations, the representation is a 2D level set representation, where the mesh is a regular grid placed on the midplane in which the shape is embedded by storing the distance to the boundary at each cell in the grid. The computer program can simulate the representation by projecting the 2D level set into 3D space to give it thickness to handle mechanical forces out of plane.

In some implementations, the representation is a 2D surface mesh (i.e., made of “shell” elements) in which the shape is explicitly represented by a 2D finite element mesh containing triangles/polygons inside the boundary and nothing outside the boundary (e.g., each 2D shell element has a thickness parameter which allows it to mechanically handle 3D forces even though it is represented in 2D only).

In some implementations, the representation is a 2D grid (i.e., of rectangles or triangles) that provides a discrete representation of the shape (e.g., some rectangles are included in the mesh when they are interior and others are excluded when exterior). A simulation can be performed using either of the approaches described above.

In some implementations, the 2D representation of each plate is processed by (i) removing isolated regions, (ii) trimming regions of the 2D level set using plate boundaries by Boolean intersecting the shape with the half space defined by each bounding plate's bounding planes.

In some implementations, after processing, the computer program can project the 2D mesh representation back into 3D space. The computer program can elect to perform this projection in the case that the optimization framework requires an input 3D shape. In instances where this is not required, e.g., using shell elements and a solid isotropic microstructure with penalization (SIMP)-based optimization framework, then the input can be the 2D mesh representation. If multiple plates are present, the 3D projections can be combined using a Boolean Union. Optionally, the post-processing can consider the tool access, minimum feature size control, and or void generation features of the 2.5-axis milling filter. Further details of the projection of 2D level set representation into 3D space is found in PCT Patent Published Application WO2021236054A1, filed May 18, 2020, entitled “Computer Aided Generative Design with Filtering to Facilitate 2.5-Axis Subtractive Manufacturing Processes,” which is hereby incorporated by reference in its entirety. The computer program can then provide 606 the input to an automatic 3D geometry generation process.

In some implementations, providing the input (e.g., a planar or quasi-planar (2.5D) mesh representation or embedding of the profile) for the automatic 3D geometry generation process can include, for example, providing the input to a to generate an input automatic 3D geometry generation process, e.g., providing the input to a solid isotropic microstructure with penalization (SIMP) or bi-directional evolutionary optimization (BESO) process.

In some implementations, the computer program detects and removes isolated regions of each candidate plate's 2D profile (e.g., 2D level set or 2D mesh representation) in the candidate solution, e.g., prior to and during a topology optimization process. For example, the computer program can detect and remove isolated regions to prepare the candidate solution for input to the topology optimization process. In another example, the computer program can detect and remove isolated regions during the topology optimization process (e.g., as a filter) to keep isolated regions from incorporating in the design, e.g., due to artifacts from the level set representation or the topology optimization process. In another example, the computer program can detect and remove isolated regions in a post-processing step, e.g., applied to output 2D level sets produced as each iteration and presented to a user as a possible candidate solution when the topology optimization process is implemented. FIG. 6B is a flow diagram of another example process 608 for processing a candidate solution for input to a shape and/or topology optimization process. The computer program generates 610 the 2D profile by removing a selected region from the 2D profile (e.g., from the 2D level set) of the 2D profiles. The computer program generates 612 a connected components map of all interior mesh elements of the 2D profile for each plate of the set of candidate plates included in the candidate solution. To eliminate undesirable isolated regions, the computer program creates a connected components map of all interior mesh elements in each 2D profile for each plate included in the candidate solution.

The computer program identifies 614 a selected region to remove from the 2D profile by determining, for each connected component in the connected components map, (A) a number of preserves and plate intersections contacted by the connected component, (B) a fraction of interior mesh elements in the connected component which are not also contained in an intersection or preserve, and (C) whether the connected component contacts a preserve which is not contacted by any other plates in the design. In other words, the computer program examines each connected component by analyzing (i) the number of preserves and plate intersections the candidate plate touches, (ii) the amount of “free” area it has (i.e., pixels in the component which are not also contained in an intersection or preserve), and (iii) whether it contacts a preserve which is not contacted by any other plates in the design.

The computer program removes 616, based on the identifying, connected components corresponding to the selected region. The computer program can use a heuristic (i.e., one or more metrics) to combine the resulting data and determine whether the component is an isolated region or if it meets a threshold importance for the structure of the design. Isolated regions can be removed from the layer level set before further processing.

In some implementations, the heuristics used by the computer program to identify and remove isolated region is as follows. The computer program identifies preserves which only contact a single plate. The computer program assigns regions attached to the identified preserves contacting only a single plate as “critical” regions, because if they are removed, then a preserve has no contact with the rest of the design. The computer program assigns regions occupied by a preserve or an intersection “interesting” regions for the purpose of isolated region removal. To identify if a connected region in a plate should be retained, the computer program determines the number of features the connected region contacts (e.g., the sum of preserves and intersection regions), the total free area (e.g., the area in the component not occupied by an interesting region). The computer program determines whether the region contains “disjoint interesting regions”, i.e., more than two features are present and there is no intersection between the two features of the profile (e.g., no voxels are tagged as being occupied by both regions). If the computer program determines that a component contains critical regions and touches more than one feature, the component is accepted as not isolated. Otherwise, the computer program requires all of the following to hold for a component to be defined as interesting: the number of interesting features contacted must not be zero, the free area must be above a threshold or disjoint intersecting regions must be present, and the number of interesting features must be greater than one or the total area must be greater than a threshold.

In some implementations, removing the selected regions includes generating plate boundaries for the candidate plates. The computer program intersects the 2D profile with the half space defined by a bounding plane for the plate boundaries and removes the selected regions based on the intersection.

In some implementations, the computer program can select plate profiles for the candidate plates using various different processes based in part on the approach used by the computer program (e.g., one of “static”, “dynamic” “simple database” and “database filtered” approaches).

In some implementations, e.g., as implemented in the static single-plate driven approach, the computer program can start a process of selecting plate profiles from a 3D discretized “starting shape.” The initial starting shape may be modified by the disconnection prevention, e.g., as described with reference to FIGS. 9A-9H, which is used to ensure that a path between all preserves is present without leaving the space occupied by the plates. At the end of the algorithm, the computer program can extract profile geometry assigned to each plate from the convex hull by flattening the portion of the 3D starting shape which lies within each plate's domain. Alternatively, the computer program can use the intersection between each plate's midplane and the starting shape to generate a plate profile.

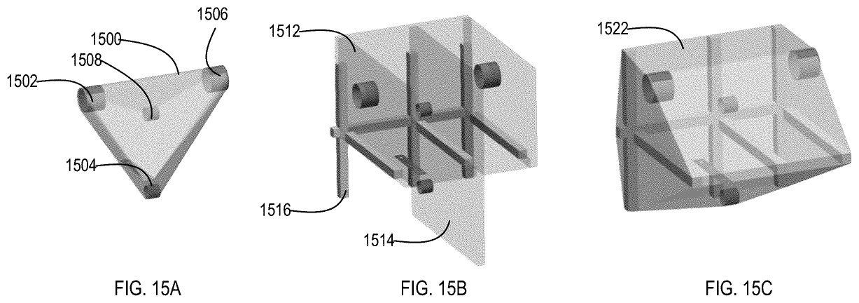

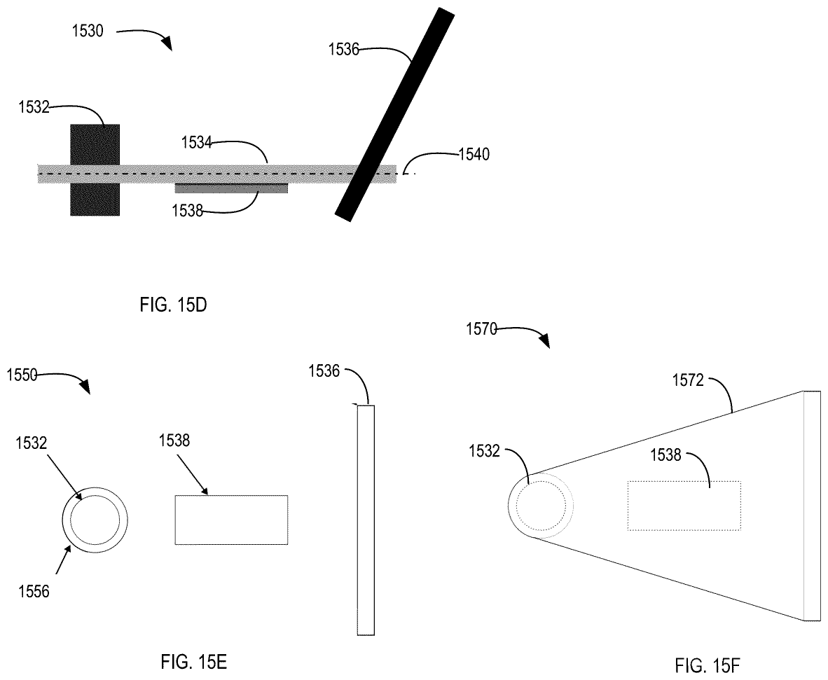

In some implementations, producing candidate solutions representing new geometries defined in the data structure includes generating a convex hull, e.g., for a “static approach.” FIGS. 15A-15C depicts a method for selecting plate profiles, e.g., for the dynamic single-plate driven approach. FIG. 15A depicts an example of a starting shape 1500 (e.g., convex hull) including preserves 1502, 1504, 1506, and 1508. The computer program uses a 3D discretized “starting shape” convex hull. This initial starting shape may be modified by a disconnection prevention, as described above, which is used to ensure that a path between all preserves is present without leaving the space occupied by the plates. At the end of the algorithm, the computer program can extract the profile geometry assigned to each plate from the convex hull by flattening the portion of the 3D starting shape which lies within each plate's domain, or by using the intersection between each plate's midplane and the starting shape.

In some implementations, the computer program can augment the convex hull of the preserves with the intersection regions between the final plate set, e.g., for a “dynamic approach.” The computer program generates an updated convex hull inclusive of the two or more preserves and the at least two candidate plates forming the candidate solution using a model of intersecting regions of the at least two candidate plates as additional input. FIGS. 15A, 15B, and 15C depict an example of an augmented convex hull starting shape. FIG. 15A depicts an example of a convex hull starting shape. For the new starting shape (e.g., the augmented convex hull) computation, intersection regions are modeled as boxes (or beams, tubes, etc.) placed along the intersection vector of the intersection region. The ends of each box are positioned to cover the extent of the original convex hull projected onto the intersection vector. FIG. 15B depicts an example of preserves 1502, 1504, 1506, and 1508 connected through candidate plates, e.g., candidate plates 1512, 1514, and intersection boxes, e.g., intersection box 1516. A new starting shape is generated to form an augmented convex hull of the intersection boxes and the preserves, e.g., augmented convex hull 1522 depicted in FIG. 15C. Once the new starting shape is created, e.g., as depicted in FIG. 15C, a final pathfinding is performed to ensure that all preserves are connected using only geometry in the intersection of the plates and new starting shape. If paths leave a new starting shape, material is added to the starting shape to ensure the system remains connected, e.g., similarly to the described implementation for disconnection processing in the static approach described above.

In some implementations, the computer program does not rely on a 3D starting shape and each candidate plate's profile is generated independently by considering the preserves and previously selected candidate plates which are associated with the candidate plate, e.g., for the “simple database” and “database filtered” approaches. FIGS. 15D-15F depict an example of a plate-wise convex hull profile, e.g., as implemented in the multi-preserve driven approaches. FIG. 15D depicts a side view 1530 of the candidate plate 1534 having a midplane 1540. Candidate plate 1534 is sliced through a midplane by preserve 1532. Candidate plate 1534 contacts preserve 1538 at a bottom interface. Candidate plate 1534 intersects with previously selected candidate plate 1536. The computer program uses each entity (e.g., preserve(s) and previously selected candidate plate(s)) in the grouping to create a 2D geometry on the plate midplane. For example, as depicted in view 1550 in FIG. 15E. The preserve 1532 (with outward offset 1556) that intersects the plate 1534 midplane are sliced by the plate midplane, then offset outward 1556 to produce a preserve profile. The computer program projects preserves (e.g., preserve 1538) which do not intersect the plate (but are still part of the plate's grouping, such as planar preserves that contact the plate's top or bottom face) onto the plate's midplane. The computer program then computes a 2D convex hull 1572 of these geometries (one for each entity in its grouping), e.g., as depicted in view 1570 in FIG. 15F.

In some implementations, the computer program implements a shape quality analysis, e.g., in any of the approaches described herein. After generating a set of candidate plates the computer program can analyze the quality of the resulting candidate plate set and validate that a candidate solution generated from the candidate plate set meet a threshold quality to present to a user in the user interface. If the computer program determines the quality does not meet the threshold quality, the plate configuration is not shown to the user.

The computer program analyzes each intersection between two plates which occurs inside an original (e.g., convex hull) starting shape. If two intersecting plates have too shallow an angle between them (e.g., the angle between the two intersecting plates is less than about 18 degrees), the computer program rejects the plate setup. If two plates do not intersect and are nearly parallel (i.e., angle between them is less than 18 degrees), the computer program validates the distance between the two plates and reject the plate set if it is less than the plate thickness.

The computer program then examines the intersections between each plate and preserves. Preserves are first classified as “Flat” (i.e., root-mean-square deviation from a plane among the triangles in the original preserve surface does not exceed a small number), and “Cylinder” (i.e., there exists an axis for which, if all of the vertices of the surface mesh are projected onto a plane perpendicular to the axis, a least squares fit of the points has an root-mean-square error of less than 1% of the computed radius). Note that these definitions differ slightly from those discussed hereafter with reference to preserve classification for mesh clustering in the “dynamic approach.”

The computer program can determine that intersections between plates and Flat preserves that occur inside the convex hull are acceptable only if the plate and Flat preserve are not too close to parallel (i.e., an angle between the Flat normal and the plate normal must be greater than about 18 degrees). Intersections between plates and Cylinder preserves inside the convex hull that have an angle between the cylinder axis and the plate normal between 18 and 72 degrees can be determined as unacceptable such that the plate setup fails the shape quality analysis.

In some implementations, the computer program can implement a shape quality analysis on a per-candidate plate basis prior to selecting plates for inclusion in the candidate solution. The shape quality analysis can filter individual candidate plates to keep them from being added to the plate set in the first place.

### Single-Plate Based Approach

As described briefly above, the shape synthesis computer program can use a single-plate based approach to generate candidate solutions. Generally, the single-plate based approach relies on plate configurations which are not prescribed, and where the preserve and candidate plate ranking remains fixed. Additionally, in this approach, shapes are represented as level sets. As briefly introduced above, the single-plate based approach can be further differentiated into sub-approaches, including a “static single-plate based approach” (or “static”) and “dynamic single-plate based approach” (or “dynamic”), described in further detail within this section of the specification. For simplicity of description, this section of the specification will include the features of the single-plate based approach that differentiate this set of approaches from others described herein. Generally, however, the details described above (unless otherwise indicated) apply to the single plate-based approach.

### Pre-Processing

In some implementations, the computer program implements pre-processing steps to the preserves (and optionally obstacles) including voxel size computation. The computer program discretizes the domain, preserves, and obstacles as level sets on a voxel grid, where the voxel size is based on the overall dimensions of the design space. For example, the voxel size is computed by equation (1) as:

$$Δ x = \frac{1}{2} \sqrt[3]{\frac{{b}_{x} {b}_{y} {b}_{z}}{N}} \qquad ( 1 )$$

where bᵢ denote the edges of a bounding box that encloses the preserve faces and N is a fixed target number of voxels (e.g., 10,000 voxels).

In some implementations, the computer program can represent preserves and obstacles in the design space as surface meshes (e.g., triangle meshes) and also as implicit surfaces (e.g., level set functions) where the level set functions are discretized on a voxel grid using the voxel sizes computed according to equation (1).

In some implementations, the computer program implements a pre-processing step including preserve surface thickening. A user can provide a set of preserves in the form of defined preserve surfaces, which the computer program can thicken through a process of preserve surface thickening. In other words, in order to produce more intuitive shapes and to integrate with downstream topology optimization processes, the computer program thickens the input preserve surfaces by extruding each triangle (or other surface mesh representation) outward in its normal direction and stitching the two surfaces together to form a solid. In instances in which the preserves are provided as solid bodies, the preserve thickening may not be performed. The amount of thickening of the preserve can be a constant number of voxels (e.g., 1.5 voxels).

In some implementations, preserve surface thickening includes, extending, by the computer program, a thickness of each surface of two preserve surfaces by extruding the triangles forming the preserve surface along a normal direction and joining the two preserve surfaces to generate a solid body.

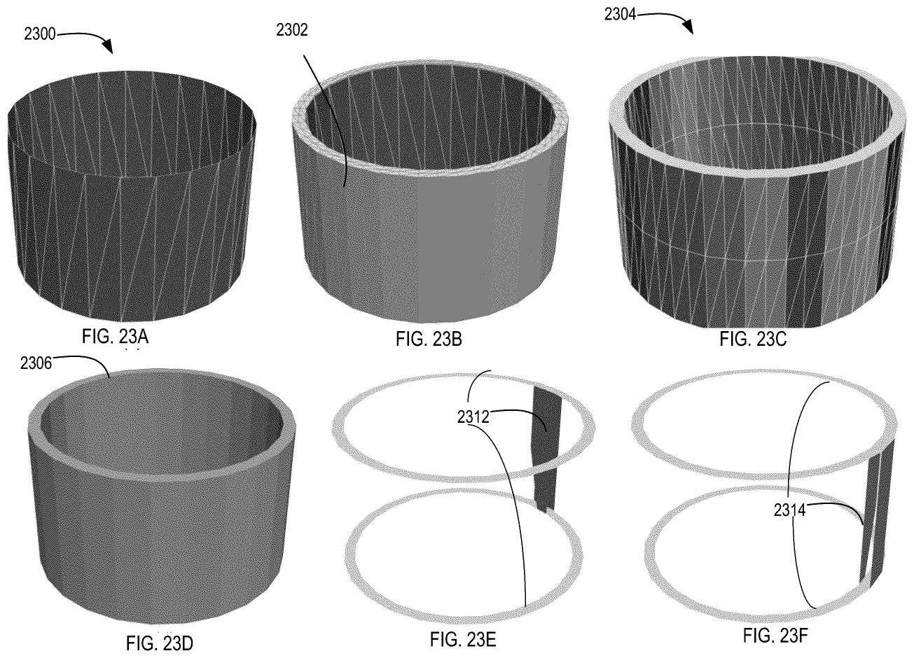

In some implementations, the computer program implements a pre-processing step including mesh clustering. For example, in instances where preserve surfaces are obtained by the computer program in another format (e.g., not in a surface mesh representation), the preserve surfaces are tessellated into triangles (e.g., as depicted in view 2300 in FIG. 23A), then extruded outward to create a solid mesh body for the preserve. FIG. 23B depicts a body 2302 generated by thickening a preserve surface. The triangles on the mesh body, e.g., as depicted in view 2304 of FIG. 23C, are grouped into clusters (e.g., using their parallel and perpendicular normal directions). Clusters are organized (e.g., ranked) based on their area and optionally the total surface area of triangles oriented parallel and optionally perpendicular to the cluster normal to produce an output set of one to four clusters for each mesh. For example, the three highest-area clusters for the mesh clusters of 2304 are depicted as cluster 2306 in FIG. 23D, cluster 2312 in FIG. 23E, and cluster 2314 in FIG. 23F.

In some implementations, the computer program implements a pre-processing step including preserve classification, e.g., as a pre-processing step of the dynamic single-plate based approach. The computer program can apply a mesh clustering algorithm to classify each preserve using three categories (i) “flat” if the input preserve surface is planar, (ii) “extruded”, and (iii) “other” if any preserve does not meet the Flat or Extruded qualifications. Generally, a preserve is classified as “extruded” if a single cluster contains most of the surface area in the thickened preserve, almost all triangles perpendicular to the cluster normal are located near the top and bottom faces of the preserve (i.e., relative to the cluster normal), and all triangles on the original preserve surface are perpendicular to the cluster normal.

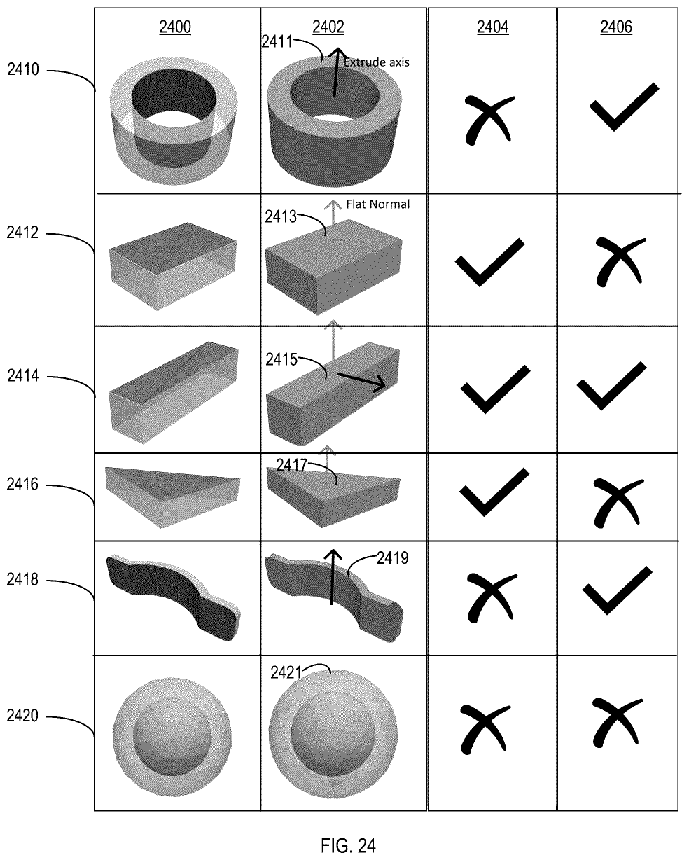

At times, a preserve can be classified as both Flat and Extruded. In that case, the computer program removes the Extruded classification unless it is reasonably narrow in the minor axis of the planar preserve (e.g., no thicker than three default plate thicknesses) and high aspect ratio (e.g., at least 3:1 major:minor planar axes). Note that “Extruded” here describes the class of shapes which can be well approximated by extruding an arbitrary 2D profile along the extrusion axis. FIG. 24 depicts a table of examples of classifications of preserves. Column 2400 depicts example preserves presented in rows 2410, 2412, 2414, 2416, 2418, and 2420. Column 2402 depicts the mesh clusters generated for the respective preserves of rows 2410-2420 with respective extrude surfaces 2411, 2413, 2415, 2417, 2419, and 2421. Columns 2404 and 2406 indicate whether or not each preserve of rows 2410-2420 is classified as “flat” (2404) or “extrude” (2406). Each preserve is represented by a surface and an extruded thickness, which is converted into a cluster and classified accordingly.

### Plate Generation

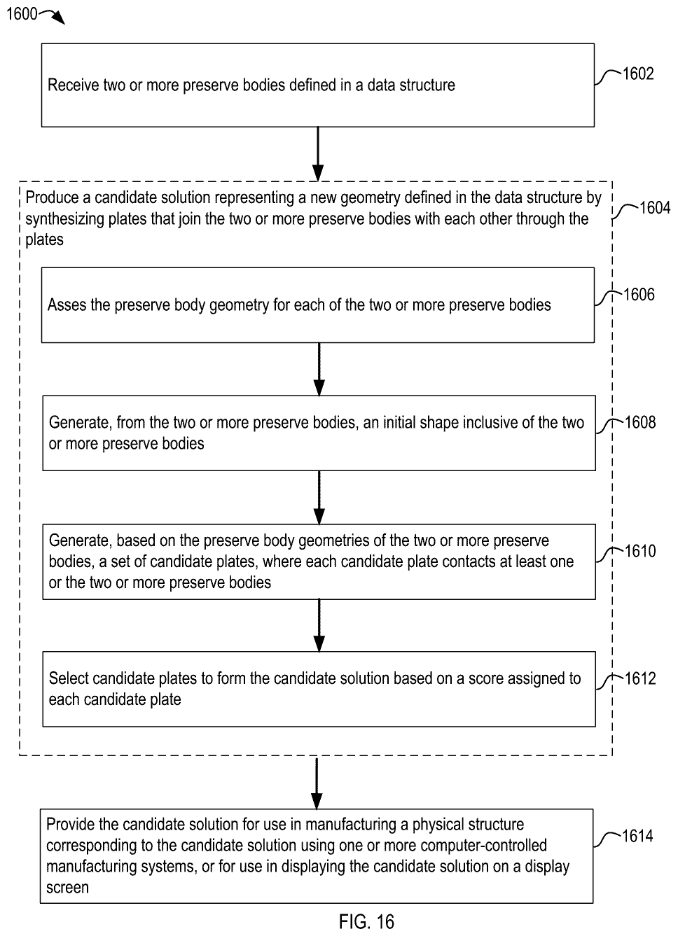

FIG. 16 is a flow diagram of an example of a process 1600 of the single-plate based approach for shape synthesis. The computer program receives 1602 two or more preserves defined in a data structure used by the shape synthesis computer program.

The computer program produces 1604, a candidate solution representing a new geometry defined in the data structure by synthesizing plates that join the two or more preserves with each other through the plates. Each of the candidate plates is defined by a base plane, a two-dimensional profile, and a thickness.

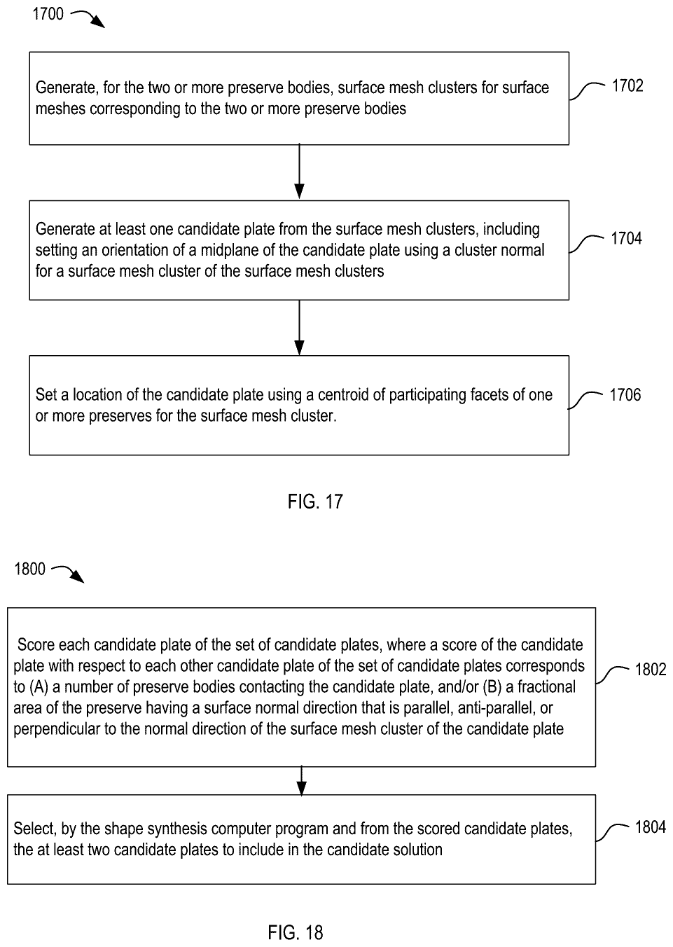

To produce 1604 the candidate solution, the computer program assesses 1606 the preserve geometry for each of the two or more preserves. The computer program can assess the preserve geometry using, for example, surface mesh clusters (e.g., as described in further detail with reference to FIG. 17).

The computer program generates 1608, from the two or more preserves, an initial shape inclusive of the two or more preserves. As will be described in further detail below, the initial shape can be a convex hull (e.g., in the case of a static single-plate driven approach) or a solid starting shape (e.g., in the case of a dynamic single-plate driven approach).

The computer program generates 1610, based on the preserve geometries of the two or more preserves, a set of candidate plates, where each candidate plate contacts at least one of the two or more preserves. Generating the set of candidate plates can include using a set of heuristics to collect a finite set of candidate plates to resolve the set of preserves in the design space. The quality of the resulting set of candidate plates can depend on the selection and tuning of the heuristics used to create candidate plates to ensure reasonable plates are present in the set of candidates. For example, the computer program can generate candidate plates from symmetry planes (e.g., as discussed with reference to FIG. 2) of the preserves.

In some implementations, candidate plates are generated from base planes from the preserves based in part on features of the preserves. In another example, the computer program can generate candidate plates from preserve surface mesh clusters (e.g., in the case of the static single-plate driven approach) or generate candidate plates based on preserve classification (e.g., in the case of the dynamic single-plate approach). In other words, the computer program can generate candidate plates having optimal contact with preserves by deriving base planes and (optionally) thicknesses for the candidate plates from the shape of each preserve body. For example, if a preserve is a cylindrical hole or fastener, a plate which contacts it with a plane perpendicular to the cylinder's axis may be desirable, while a flat plate preserve may have an optimal contact with a candidate plate oriented either parallel or perpendicular to the preserve (i.e., not at an oblique angle).

In some implementations, the shape synthesis by the computer program generates candidate plates using surface mesh clusters. FIG. 17 is a flow diagram of an example of a process 1700 for surface mesh clustering. The computer program generates, based on the preserve geometries of the two or more preserves, the set of candidate plates. To generate the set of candidate plates, the computer program generates 1702, for the two or more preserves, surface mesh clusters for surface meshes corresponding to the two or more preserves.

The computer program generates 1704 at least one candidate plate from the surface mesh clusters, including setting an orientation of a midplane of the candidate plate using a cluster normal for a surface mesh cluster of the surface mesh clusters. The computer program sets 1706 a location of the candidate plate using a centroid of facets of the surface mesh cluster for the preserve.

In some implementations, the computer program generates a set of candidate plates based on the preserve geometries of the preserves in the design environment. For example, the computer program generates a symmetry plate having a midplane aligned with a global or local symmetry plane of the preserves.

The computer program can use various approaches to analyze each preserve in isolation and use the preserve geometry to create a set of candidate base planes that meet a set of requirements for the particular preserve. For example, the computer program can cluster the surface mesh of the thickened preserve and generate candidate plates directly from the mesh clusters, using the cluster's average normal and the centroid of the participating facets of the thickened preserves to set the midplane orientation and location, respectively. In another example, preserves classified as Flat are populated with a candidate plate such that the top or bottom face of the preserve is coplanar with the preserve surface. Preserves classified as Other receive one candidate plate for each of the top four clusters.

In some implementations, (e.g., as described with reference to FIG. 17) in the static single-plate driven approach, the surface mesh of a thickened preserve is clustered and candidate plates are created directly from the mesh clusters, using the cluster's average normal and the centroid of the participating facets of the thickened preserves to set the midplane orientation and location, respectively.

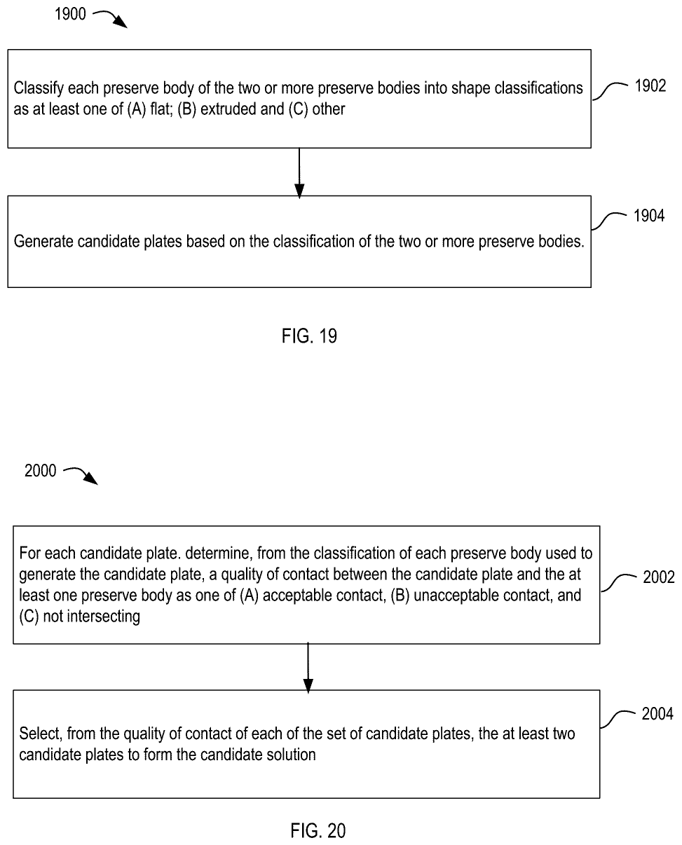

In some implementations, in the dynamic approach, the computer program generates candidate plates based on the preserve geometries. For example, the shape synthesis computer program can generate candidate plates using a classification of two or more preserves. FIG. 19 is a flow diagram of an example of a process 1900 for generating candidate plates. The computer program classifies 1902 each preserve into shape classifications as at least one of (A) flat, (B) extruded and (C) other, and generates 1904 candidate plates based on the classification of the two or more preserves. Preserves classified as Flat are populated with candidate plates such that its top or bottom face is coplanar with the preserve surface. Preserves classified as Other receive one candidate plate for each of the top four clusters, e.g., similarly to the static single-plate driven approach. Preserves which are categorized as Extruded result in candidate plates which have a normal parallel to the extrusion axis.

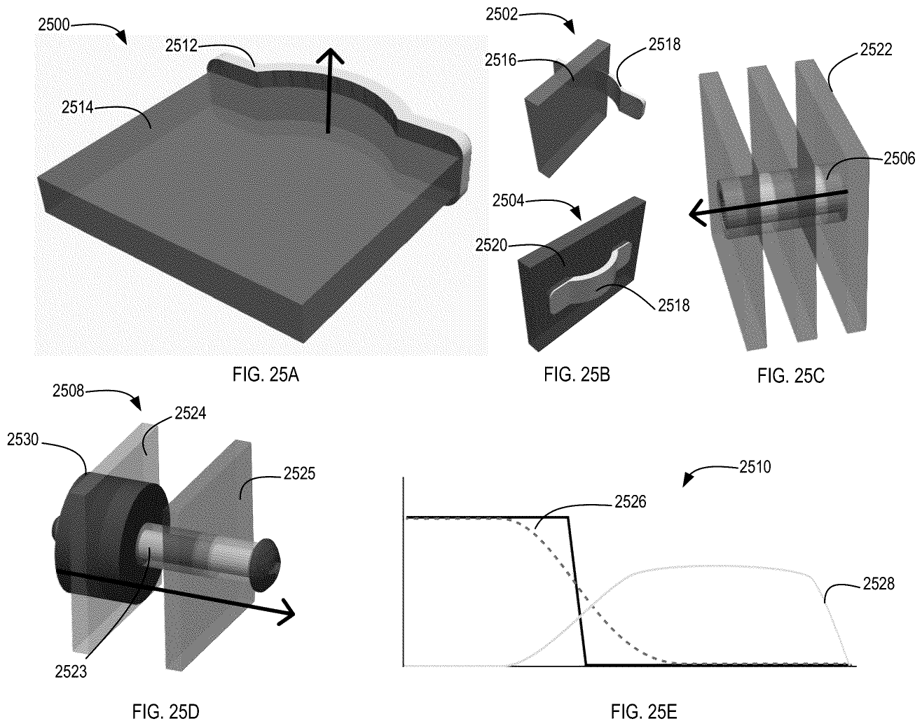

For preserves which are categorized as Extruded the computer program generates candidate plates having a normal parallel to the extrusion axis. For example, as depicted in the example 2500 in FIG. 25A, the computer program defines the thickness of a plate 2514 based on the Extruded preserve 2512. The computer program can initially set the thickness of the plates to a default thickness and adjust the thickness using a “snapping” method as described with reference to FIGS. 26A-26B. FIG. 25B depicts two examples 2502 and 2504 of non-desirable results for plate orientations with respect to preserve 2518, where the computer program has oriented the of plates 2516 and 2520 with respect to preserve 2518 in an unexpected and less desirable manner. As depicted in the example 2508 in FIG. 25C, the computer program can generate multiple candidate plates, e.g., candidate plate 2522, along the extrusion direction aligned with an axis of a preserve 2506 (e.g., the cylindrical element). At times, the characteristics of an Extruded preserve can be used to incorporate additional logic for the location of candidate plates to avoid intersections with nearby obstacles while still providing high quality contact between the candidate plate and the preserve. For example, as depicted in the example 2508 in FIG. 25D, a preserve 2523 is selected as a preserve surface and includes an obstacle 2525 obscuring part of the length of the preserve body. The computer program can select a candidate plate 2524 having a default thickness along an axis of the preserve 2523. By traversing along the Extruded direction of the preserve, the computer program counts nearby voxels which contain an obstacle (e.g., as represented by the solid black line in plot 2510 in FIG. 25E). To avoid candidate plates partially intersecting the obstacle, the computer program implements a moving average of the obstacle voxel counts with a kernel width equal to the default plate thickness (e.g., as represented by the line 2526 in FIG. 25E). Finally, the computer program computes a heuristic score for locating the candidate plate along the Extrusion (e.g., represented by the line 2528 in FIG. 25E). The computer program can determine a heuristic score for each of the candidate plates of FIG. 25C, where a candidate plate is placed along the extrusion axis at a location corresponding to a maximum of the heuristic score. For example, determine that a score for plate 2525 is higher because it provided unhindered contact with preserve 2523, whereas the score for plate 2524 is lower due to the presence of the obstacle 2530.

Candidate plates, as used in this specification, can be defined by one or more of a base plane (e.g., midplane or a plane of the top or bottom face of the plate), a thickness above/below the normal direction of the base plane, a domain inside which the plate must remain (i.e., during subsequent optimization processes), and a profile or other specification of the shape that is extruded to form the candidate plate. A base plane can control a candidate plate such that it remains coplanar to a desired face when the thickness changes. The computer program can select a default thickness for the generated candidate plate, e.g., to be 2.8 times the voxel size.

In some implementations, the computer program can adjust the thickness of the candidate plate, e.g., a candidate plate 2608 depicted in the example 2600 of FIG. 26A. The computer program can set a default thickness for each candidate plate, and then use a “snapping” process by which the top and bottom face of the plate are adjusted to improve the overall quality of the plate set, e.g., in the single-plate driven approaches. As depicted in FIG. 26A, the candidate plate 2608 has the default initial thickness 2618. The example 2600 includes three preserves bodies 2610, 2612, and 2614 with “Flat” faces parallel to the midplane 2606 of the candidate plate 2608. The computer program can adjust at least one of (A) a first location of the first surface 2602 of the candidate plate 2608, and (B) a second location of the second surface 2604 of the candidate plate 2608 with respect to a base plane 2606 defined for the candidate plate 2608. The computer program can adjust the thickness by adjusting the first and/or second surfaces of the candidate plate to contact with one or more preserves 2610, 2612, 2614. For example, as depicted in example 2620 of FIG. 26B, the thickness of candidate plate 2608 is adjusted such that surface 2604 contacts preserve 2610 and the surface 2602 contacts a surface of preserve 2614. In each case, the respective surface can be adjusted along an axis perpendicular to the base plane 2606, and without exceeding a maximum deviation thickness 2616 from the base plane 2606 or an overall maximum thickness (e.g., 2X of thickness 2616) for the candidate plate. The computer program then updates the thickness 2620 of the candidate plate to define an updated thickness and updates a location of the base plane in response to the adjusting of the at least one of the first surface and the second surface.

The computer program can implement a “max snap band” which defines a region above and below the plate midplane (e.g., 2.1 voxels away from the midplane). The computer program can only consider preserves which have an input surface inside the “max snap band” for snapping (e.g., preserve 2612 is not considered).

In some implementations, a base plane may be aligned with one or more symmetry planes defined with respect to the preserves, such that the computer program does not adjust the location of the surfaces of the candidate plate in a manner that the midplane location of the candidate plate shifts off of the symmetry plane. In this case, the computer program adjusts surfaces to only the closest preserve face and allows the preserve face and midplane location to determine the plate thickness.

### Plate Selection

Referring back to FIG. 16, the shape synthesis computer program selects 1612 candidate plates to form the candidate solution based on a score assigned to each candidate plate. In some implementations, selecting candidate plates to form the solution includes assigning, by the computer program, a score to each of the generated candidate plates and selecting the candidate plates based on the score of the candidate plates. These score components are combined using a set of tuned weights to construct a total score for each candidate plate. The total plate score is used by the computer program in selecting which candidate plates to select for inclusion.

In some implementations, the computer program can implement static or dynamic scoring of the candidate plates. For example, in the “static approach,” a score for each candidate plate is determined at the beginning of a selection process and remains fixed throughout. In the “dynamic approach,” the computer program updates the context score of each candidate plate after every plate selection for inclusion in the candidate solution. In this way, the “dynamic approach” adapts to candidate plate intersection scores and other preserve scores as the selection progresses, reducing the likelihood of redundant plates (two plates doing similar jobs).

FIG. 18 is a flow diagram of an example process 1800 for scoring candidate plates. The computer program scores 1802 each candidate plate of the set of candidate plates, where a score of the candidate plate with respect to each other candidate plate of the set of candidate plates corresponds to (A) a number of preserves contacting the candidate plate, and/or (B) a fractional area of the preserve having a surface normal direction that is parallel, anti-parallel, or perpendicular to the normal direction of the candidate plate.

In some implementations, assigning a score to each of the candidate plates includes assigning an intrinsic score and/or a context score to the candidate plate. The intrinsic score includes a static ranking of the candidate plate with respect to each other candidate plate of the set of candidate plates. The context score includes a dynamic ranking of the candidate plate with respect to at least one other candidate plate of the set of candidate plates selected to form the candidate solution.

Table (2) represents various features that the computer program can implement (e.g., at different weights) to score each of the candidate plates.

TABLE 2

| | | |
|---|---|---|
| Intrinsic Score | Cluster score | For plates which came from a preserve clustering, the |
| | | fraction of the area of the preserve which has normal |
| | | parallel, anti-parallel, or perpendicular to the source |
| | | cluster. |
| | Aspect Ratio | Approximate the plate's aspect ratio in the design |
| | | space |
| | Plate Source | This is an enumeration score capturing what kind of |
| | | candidate plate this is, with higher values for Extruded |
| | | and Plate preserves, and connecting plates which |
| | | complete a symmetry pair (used in secondary |
| | | selection of dynamic approach) |
| Context Score | Other Preserves | Scores intersection between this plate and other |
| | | preserves. Also provides a bonus if this candidate |
| | | plate is congruent with a candidate plate belonging to |
| | | a different preserve. |
| | Other Preserves | Provides a bonus for each preserve this plate contacts |
| | | acceptably that isn't already marked as connected. |
| | Plate Intersection | Captures the quality of the intersection between a |
| | | candidate plate and plates already accepted into the |
| | | candidate solution, favoring perpendicular plate |
| | | configurations, and penalizing plates that intersect |
| | | inside the design domain at an odd angle and parallel |
| | | plates which are too close. |
| | Bad Preserve | A penalty score for cases where a candidate plate |
| | Intersection | intersects with a preserve in an undesirable way (i.e., |
| | Penalty | at an odd angle, or barely clipping the edge of a |
| | | preserve). |
| | Unused Preserve | A bonus used in secondary selection of “dynamic |
| | Plate Bonus | approach” for candidates that were generated from a |
| | | preserve but not selected as part of initial selection |
| | Symmetry Bonus | A bonus applied if this candidate plate is symmetric |
| | | with an already accepted plate across a detected |
| | | symmetry plane |

The computer program selects 1804, from the scored candidate plates, the at least two candidate plates to include in the candidate solution. In some implementations, the computer program selects a set of candidate plates prior to scoring and selecting candidate plates based on the scoring. For example, in the “static approach,” the computer program can pre-select candidate plates generated from symmetry planes and contact at least one of the preserves. A candidate plate can be aligned with a symmetry plane of one or more symmetry planes of the preserves.

In instances where a candidate plate generated from a symmetry plane has at least a threshold quality of contact with all the preserves in the design space, the computer program can select to not include any further candidate plates and proceed to plate set refinements, e.g., disconnection prevention, split/bounding of plates, etc. In the “static approach,” the computer program considers the symmetry-driven plates as already present in the candidate solution when computing scores for the plate selection heuristic described above.

In some implementations, a quality of contact, e.g., acceptable contact between the preserve and the candidate plate, is used by the computer program to select one or more of the candidate plates for inclusion in the candidate solution. Low quality contact can result in a final candidate plate configuration to have lower quality in manufacturing, CAD, and/or for aesthetic purposes.

In some implementations, a preserve classification is used to drive both generation and selection of candidate plates, where preserve classification is used in part to define a quality of contact between a candidate plate and a preserve. For example, preserve classification can be used in the “dynamic approach” to select candidate plates for inclusion in the candidate solution. FIG. 20 is a flow diagram of an example of a process 2000 for selecting candidate plates using preserve classification. The computer program determines 2002, for each candidate plate and from a classification of each preserve used to generate the candidate plate, a quality of contact between the candidate plate and the at least one preserve as one of (A) acceptable contact, (B) unacceptable contact, and (C) not intersecting. A Flat preserve can be contacted by a plate in an Acceptable way if the top or bottom face of the preserve is parallel to the Flat and contacts it such that the preserve surface is coplanar with the plate face and the thickness of the preserve is contained inside the plate. An Extrude preserve can be contacted by a plate in an Acceptable way if its normal is aligned with the extrusion axis and it overlaps for at least half of the smaller of the plate thickness and the extrude length. Any penetration of a preserve into the body of a Flat or Extrude plate can be considered Unacceptable contact if it does not fit into one of the above categories, except that perpendicular plates contacting a Flat preserve are treated as Not Intersecting to avoid penalizing them in the plate scoring. Any penetration of a preserve into the body of an Other preserve can be considered Acceptable contact.

In some implementations, the computer program determines a quality of contact based on a degree of intersection of the candidate plate and at least one preserve, e.g., implemented in the “static approach.” The computer program scores the candidate plates based on a degree of intersection between a midplane of the candidate plate with the at least one preserve where the degree of intersection includes (A) containment of the at least one preserve within the candidate plate or (B) a crossing of the at least one preserve of the midplane of the candidate plate.

The computer program selects 2004 candidate plates for inclusion in the candidate solution from the quality of contact.

Referring back to FIG. 16, the computer program selects 1612, from the set of candidate plates, at least two candidate plates to form the candidate solution. For example, referring to FIG. 7B-7C, the computer program selects at least two candidate plates to form candidate solutions using a “static approach” (e.g., FIG. 7B) and a “dynamic approach (e.g., FIG. 7C).

Referring back to FIG. 16, the computer program provides 1614, the candidate solution for use in manufacturing a physical structure corresponding to the candidate solution using one or more computer-controlled manufacturing systems, or for use in displaying the candidate solution on a display screen.

### Post Processing

In some implementations, the shape synthesis computer program applies disconnection resolution to generate a modified or updated candidate solution. In both the “static approach” and “dynamic approach” the computer program uses the “starting shape,” defined as the 3D geometry generated prior to the plate selection process and which represents a shape that is guaranteed to contact all the preserves (e.g., a convex hull of the preserves with additional modifications to ensure it forms a connected body). The starting shape is used to create the profile for each plate in these methods and the starting shape may be further updated to help create a connected system once plates are selected. A general process of disconnection resolution is described with reference to FIGS. 9A-10F.

In some implementations, the computer program uses connected components to resolve disconnections after the candidate solution is produced including a set of candidate plates, e.g., in the “dynamic approach” depicted in FIGS. 10A-10F. To create connecting plates, the computer program adjusts scoring and ranking of candidate plates to generate and select candidates to bias the selection of candidate plates toward the connectivity of the candidate solution. For example, an updated set of candidate plates including preserve-driven candidate plates with new candidates derived from the extrude preserves, bounding box, symmetry planes, the convex hull, etc., are generated to create an updated set of possibilities. Each of the updated set of candidate plates is scored using an updated scoring method, for example, a new scoring mechanism which evaluates the connectivity and quality of a set of candidate plates forming a system of candidate plates. The computer program assigns a system score (i.e., the score of the set of candidate plates) to each candidate connecting plate by scoring the accepted plates and the candidate plate as a whole system. FIG. 10E depicts a scoring 1026 of each of the candidate connecting plates, and FIG. 10F depicts a highest performing candidate connecting plate 1028 for inclusion in the final candidate solution 1030.

FIG. 21A is a flow diagram of an example of a process 2100 for resolving disconnections. The computer program intersects 2102 the initial shape with a midplane of each candidate plate of the at least two candidate plates. FIG. 10A depicts an example candidate solution 1000 including candidate plates 1002, 1004, 1006 selected for inclusion in the candidate solution to connect preserves 1008, 1010, 1012, and 1014.

The computer program determines 2104, from the intersections, connected components for each of the at least two candidate plates, and generates 2106 for each of the connected components, an intersecting connected components map between the connected components for the at least two candidate plates. FIG. 10B depicts two separate regions 1018 and 1020 of the candidate solution identified in the connected components map, indicative of a disconnection caused by obstacle 1016 for which a connecting plate is required.

In response to the determining that there is a disconnection in the intersecting connected components map, the computer program generates 2108 a set of connecting candidate plates (e.g., as depicted in FIG. 10C where a set of candidate connecting plates 1022 is generated using a variety of approaches as described above) and selects a connecting plate from the set of connecting candidate plates to form an updated candidate solution. FIGS. 10D-10F depict a subset of candidate plates 1024 which resolve the disconnection by reducing the candidate solution to a single connected component, where computer ranks the subset of candidate plates according to selection heuristics (described with reference to Table (2)) and selects additional candidate plate 1030 in FIG. 10F to resolve the disconnection.

The computer program can generate a new set of connecting candidate plates derived from the Extrude preserves, the bounding box, symmetry planes, the convex hull, and other plates to create a much larger set of possibilities. The set of connecting candidate plates can be scored in the same manner as described above with reference to the “dynamic approach,” where the computer program can select one or more connecting plates to form the updated, connected candidate solution.

### Multi-Preserve Based Approach

In some implementations, the shape synthesis computer program uses a multi-preserve-based approach to generate candidate solutions. As introduced above, the multi-preserve driven approach includes generating candidate plates where each of the candidate plates conforms to a specified database of acceptable configurations, and where a list including preserves and candidate plates is updated after each selection of a candidate plate to include into the candidate solution. The multi-preserve driven approach can further be distinguished into two sub-approaches: (i) simple database multi-preserve driven approach (or “simple database approach”), and (ii) database-filtered multi-preserve driven approach (or “database-filtered approach”). As opposed to the single-preserve driven approach, implementing the multi-preserve driven approach does not include discretizing the model geometry onto a voxel grid but instead performing the computations using surface meshes (e.g., triangle mesh).

With the multi-preserve driven approach, the steps of defining the preserves/obstacles, generating a set of candidate plates, scoring/ranking the set of candidate plates, and selecting a highest-ranking candidate plate (and resolving disconnections) occurs iteratively (e.g., at least twice) with each additional selected candidate plate included into the candidate solution.

### Pre-Processing

In some implementations, the computer program implements pre-processing steps including a symmetry analysis to classify preserves into categories. The preserves are analyzed in an initial (i.e., unthickened) state. The preserves are represented as surface meshes (e.g., triangle mesh representation). The computer program assigns a category to each preserve, e.g., based on a first category of a list of categories that applies to the preserve. In some implementations, categories include spherical (e.g., preserves that have an infinite order symmetry point), cylindrical (e.g., preserves that have an infinite order symmetry axis), sphericallike (e.g., preserves defined as having three high-order symmetry axes through the center point), cylindricallike (e.g., preserves having one high order symmetry axis, but not infinite), circular (e.g., preserves that are planar and there is a point on the plane that has infinite order symmetry with only one edge loop), flatring (e.g., preserves that are Circular but have two concentric loops, i.e., a circle with a hole cut out or an annulus shape), rectangular (e.g., preserves that are also planar and have two orthogonal symmetry lines), flat (e.g., preserves are planar), and unrecognized (e.g., preserves do not fit into any of the above cases). “Flat” is used here in both classification methods with the same definition, i.e., a Flat preserve contains vertices that are all coplanar. Although described here as a pre-processing step, the computer program can classify preserves into categories at the initiation of each iteration of the candidate plate generation process, where the computer program can re-classify the updated list of preserves in the design space.

In some implementations, e.g., in the simple database approach, the computer program implements pre-processing steps including computing the possible combinations of two or more preserves (i.e., “Groupings”). For each grouping, the computer program analyzes preserves (e.g., either original preserves or pseudo-preserves created from previously accepted plates) and checks the grouping against a set of predefined valid configurations, e.g., stored in a database. Each valid configuration includes a method for defining the base plane for a candidate plate derived from the configuration. The computer program uses a first (e.g., highest ranking) configuration that matches the grouping to create a candidate plate. In the case that a grouping does not match one of the valid configurations, the computer program does not generate candidate plate for the grouping.

### Iterative Candidate Plate Generation/Selection Process

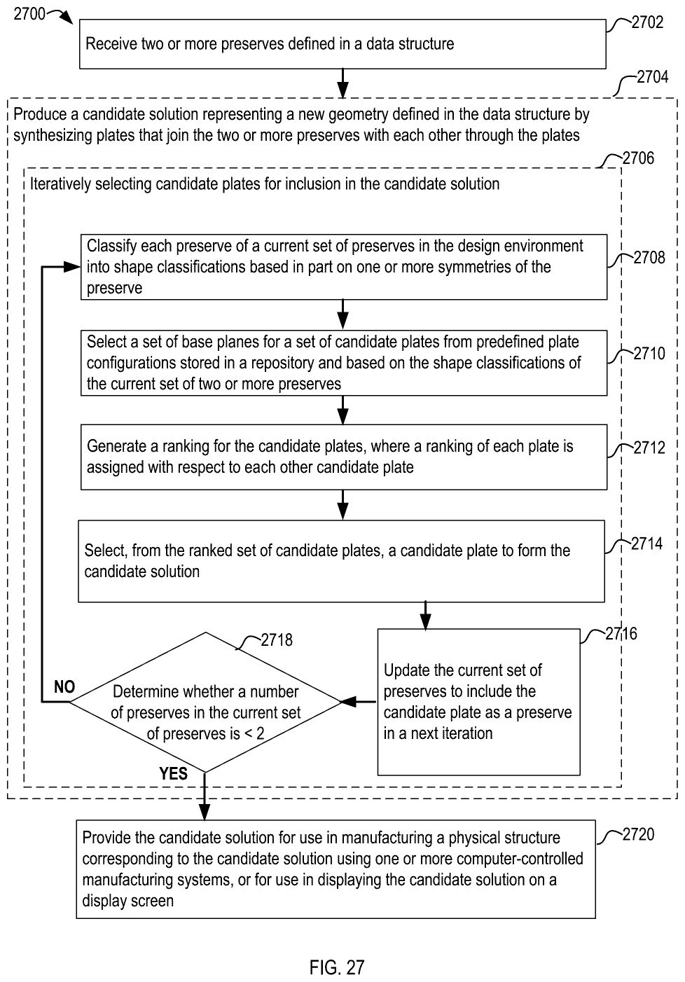

FIG. 27 is a flow diagram of an example of a process 2700 of the multi-preserve-based approach for shape synthesis. The computer program receives 2702 two or more preserves defined in a data structure used by the shape synthesis computer program and produces 2704 a candidate solution by synthesizing candidate plates that join the two or more preserves with each other through the candidate plates. Each of the candidate plates is defined by a base plane, a two-dimensional profile, and a thickness, where the candidate solution represents a new geometry defined in the data structure. The computer program provides 2720 the candidate solution for use in manufacturing a physical structure corresponding to the candidate solution using one or more computer-controlled manufacturing systems, or for use in displaying the candidate solution on a display screen.

Producing 2704 the candidate solution by the computer program includes iteratively selecting 2706 candidate plates for inclusion in the candidate solution to connect the two or more preserves until a number of unconnected preserves remaining in the design space is less than two (i.e., equal to 1).

To iteratively select 2706 the candidate plates for inclusion in the candidate solution, the computer program classifies 2708 each preserve of a current set of preserves (starting with the initially received two or more preserves) in the design environment into shape classifications based in part on one or more symmetries of the preserve, where the computer program generates candidate plates based on the shape classifications of the current set of preserves, e.g., as described above in the “pre-processing” section.

The computer program selects 2710 a set of base planes for a set of candidate plates from predefined plate configurations stored in a repository and based on the shape classifications of the current set of preserves. Depending on the selected approach, the base planes can be defined based on groupings of preserves (e.g., in “simple database”) or using a variety of heuristics and subsequently filters the generated candidate planes for the base planes using a database of acceptable configurations (e.g., in “database filtered”).

The computer program generates 2712 a ranking for the candidate plates. A rank of each candidate plate is assigned with respect to each other candidate plate of the candidate plates, further details of the ranking is described below.

The computer program then selects 2714, from the ranked set of candidate plates, a candidate plate to form the candidate solution (further details on the selection of candidate plates are described below). Each of the “simple database approach” and “database filtered approach” selects a first candidate plate to include in the candidate solution before proceeding to updating 2716 the set of preserves and determining (2718) if all preserves are connected, i.e., if the number of preserves of the current set of preserves in the design environment is less than two.

After each candidate plate is selected 2714 to form the candidate solution, the computer program updates 2716 a current set of two or more preserves to include in the candidate plate as a preserve in a next iteration. With each iterative process, the previously selected candidate plates in the candidate solution are considered by the computer program as preserves, and preserves contacting (e.g., incorporated into) selected candidate plates are “absorbed” into the candidate plates to form new preserve(s) (e.g., one new preserve). In other words, the computer program updates 2716 the current set of two or more preserves to include the candidate plate by generating a second preserve including a first preserve having at least a threshold contact with a selected candidate plate or by defining a new preserve that is the selected candidate plate.

The computer program determines 2718 whether a number of remaining preserves in the current set of preserves is N<2. The computer program will iterate 2706 process steps 2708-2718 to generate and rank candidate plates and select a candidate plate for inclusion in the candidate solution until the number of preserves in the current set of preserves is less than 2, i.e., where the candidate solution including the set of candidate plates represent a unified “preserve.” In other words, computer program continues to iteratively select candidate plates for inclusion in the candidate solution until all geometries are connected or no candidate planes can be formed.

In the case where the number of preserves in the current set of preserves is N≥2, then the computer program returns to the classification 2708 of the current set of preserves. In the case where the number of preserves in the current set of preserves is N<2, the computer program provides 2720 the candidate solution.

In some implementations, the computer program generates candidate plates from symmetry planes for the preserves, where the symmetry planes can be used to form midplanes of candidate plates. Additionally, the computer program can consider partial symmetry for generating candidate plates, in which only a subset of the preserves and/or obstacles is included in the symmetry detection. For example, both the “simple database” and the “database filtered” approaches use symmetry planes for a grouping (e.g., a subset) of preserves and accepted plates as one of its predefined valid configurations. Additionally, in the database filtered approach, the computer program generates base planes for consideration using both global symmetry of the preserves as well as by analyzing pairs of preserves for symmetry planes.

FIG. 29 is a flow diagram of an example of a process 2900 for generating and selecting candidate plates, e.g., in the simple database approach. As described above, in the multi-preserve driven approaches, a database is used to select from pre-defined candidate plates based on groupings of preserves (e.g., original preserves and/or previously selected candidate plates in the solution). The computer program identifies 2902 for the two or more preserves and based on the shape classifications of the two or more preserves, preserve groupings corresponding to at least two of the two or more preserves.

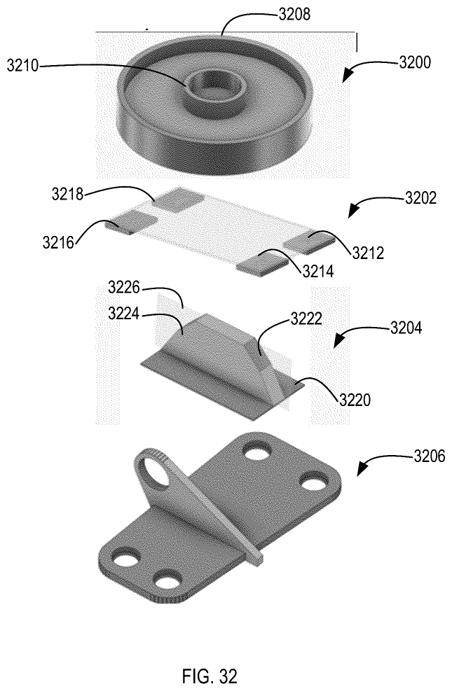

The computer program determines 2904, for each grouping of the identified preserve groupings, a corresponding validated candidate plate for the group. FIG. 32 depicts examples of plate configurations 3200, 3202, 3204, 3206 for the simple database approach, where a ranking of the plate configurations is arranged from the highest value/priority to a lowest value/priority. Plate configuration 3200 is an example of an inner/outer cylinder configuration including two concentric cylinder preserves 3208, 3210 which can be connected by a plane through the center of mass of one of the preserves. A base plane for configuration 3200 can be defined by a normal aligned with the cylinder axis, and that intersects the center of mass of the preserves. Plate configuration 3202 is an example of a planar configuration where all preserves 3212, 3214, 3216, and 3218 in the group lie on a single plane with normal parallel to the base plane normal. A base plane for configuration 3202 can be defined by a normal aligned with the preserve plane normal, and where the base plane is configured such that the top/bottom face of the plate contacts the preserves. Plate configuration 3204 is an example of a symmetric configuration including a group of preserves 3220, 3222, 3224 that contain a symmetry plane 3226 intersects all the preserves in the group. A base plane for configuration 3204 can be defined by the detected symmetry plane. Plate configuration 3206 is an example of a cylinder configuration where one or more preserves in the group are classified as Cylinder with a parallel axis. A base plane for configuration 3206 can be defined by such that a plate midplane has normal parallel with cylinder axis and goes through the cylindrical preserve(s) centroid. The computer program can reference a database including a set of plate configurations corresponding to groupings of two or more preserves. The computer program determines if the grouping matches one of the set of pre-defined configurations in the database where each of the pre-defined configurations satisfies a candidate base plane as defined by a rule listed in FIG. 32.

In some implementations, the computer program sorts the candidate plates according to (A) a number of geometries in each grouping that was used to generate each candidate plane and (B) a rank of the matching configuration in the database. The first/top candidate is tentatively selected to be added to the candidate solution.

In response to determining the corresponding validated candidate plate for the grouping, the computer program adds 2906 the candidate plate to the set of candidate plates. In response to determining no corresponding validated candidate plate for the grouping, the computer program disregards 2908 the grouping.

In some implementations, e.g., in the database-filtered approach, rather than selecting candidate plates from groupings of preserves, (e.g., as described with reference to the simple database approach), the computer program can use a variety of heuristics to create candidates including for example, global symmetry, axis-aligned planes at the model's center of gravity, pairwise local symmetry, and planes through each preserve's center of gravity parallel to the global axes and large groups of preserve triangles. The candidate base planes are then filtered by checking each against a list of accepted plate configurations. In other words, the shape synthesis computer program produces the candidate solution by filtering candidate plates against a repository of validated candidate plates for the two or more preserves.

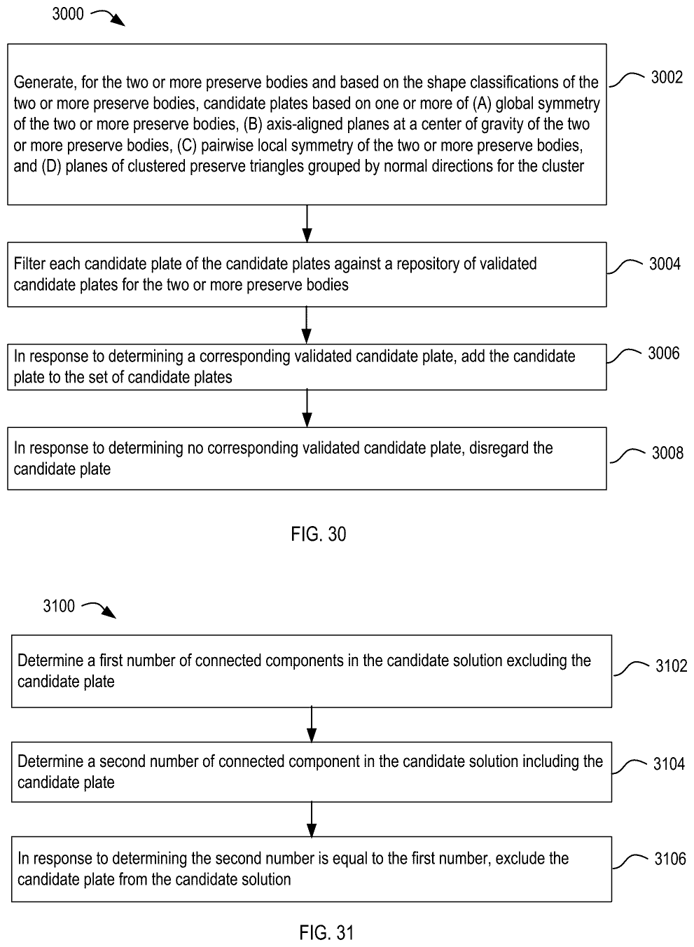

In some implementations, the computer program can select/filter candidate plates for inclusion in the candidate solution (e.g., the selecting 2714). FIG. 30 is a flow diagram of an example of a process 3000 for selecting and filtering candidate plates against a database of validated candidate plates. The computer program generates 3002, for the two or more preserves and based on the shape classifications of the two or more preserves, candidate plates based on one or more of (A) global symmetry of the two or more preserves, (B) axis-aligned planes at a center of gravity of the two or more preserves, (C) pairwise local symmetry of the two or more preserves, and (D) planes of clustered preserve triangles grouped by normal directions for the cluster.

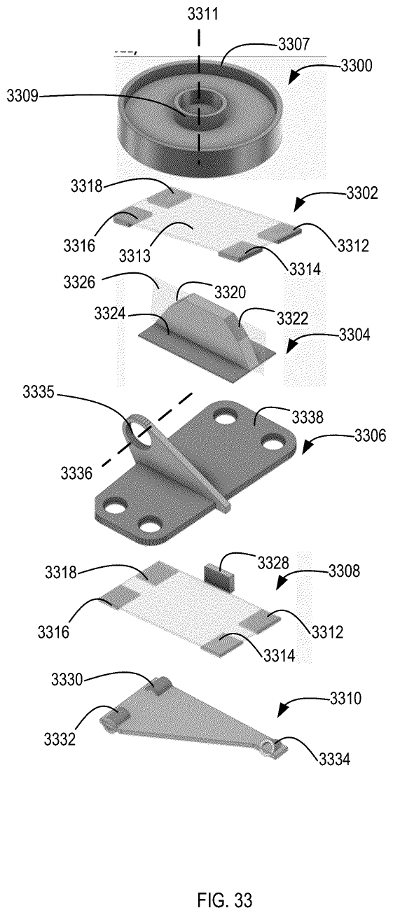

The computer program filters 3004 each candidate plate of the candidate plates against a repository of validated candidate plates for the two or more preserves. The preserves which participate in the configuration detection are all preserves which intersect the base plane of the candidate plate being analyzed, and they are analyzed together as well as in sub-groups to create multiple valid configurations for a given input plane, and which are handled independently by a selection process. FIG. 33 depicts various acceptable configurations 3300, 3302, 3304, 3306, 3308, and 3310 for candidate plates, and which are ordered according to their rank, which can be used by the computer program as a criteria for sorting candidate plates. In some cases, the base plane is adjusted to better match the classification.

Plate configuration 3300 is an example of an inner/outer cylinder configuration including two concentric cylinder preserves 3309, 3307 which can be connected by a plane through the center of mass of one of the preserves. A base plane for configuration 3300 is selected to have a normal parallel to the cylinder axis 3311.

Plate configuration 3302 is an example of a planar configuration where all preserves 3312, 3314, 3316 in the group lie on a single plane with normal parallel to the base plane normal. A base plane location for configuration 3302 can be adjusted so that plate top/bottom face touches the preserve plane 3313.

Plate configuration 3304 is an example of a symmetric configuration including a group of preserves 3320, 3322, 3324 intersecting the plane and which are symmetric about the plane 3326. A base plane for configuration 3304 can be defined by the detected symmetry plane.

Plate configuration 3306 is an example of a cylinder configuration where one or more of preserves 3335 and 3338, e.g., preserve 3335 in the group are classified as Cylinder with a parallel axis 3336. A base plane for configuration 3306 can be defined by such that a plate midplane has normal parallel with cylinder axis 3336 and goes through a centroid of the cylindrical preserve(s) 3324.

Plate configuration 3308 is an example of a partially planar configuration where subset of the preserves are within the planar configuration (e.g., preserves 3312, 3314, 3316, 3318) and one or more preserves are outside the planar configuration (e.g., preserve 3328). A base plane for configuration 3308 in profile generation can be restricted to only the preserves which are planar, e.g., preserves 3312, 3314, 3316, 3318.

Plate configuration 3310 is an example of an “other” configuration in which a base plane which does not fall into one of the above categories, but still intersects the preserves, e.g., preserves 3330, 3332, 3334, and existing plates in a reasonable way.

The computer program can use the acceptable plane configurations, e.g., the acceptable plane configurations shown in FIG. 33, to filter and optionally adjust the set of candidate base planes, either their location or the set of preserves which are associated with the plate for profile generation purposes. Note that this grouping of preserves in the “database filtered approach” is deduced after configuration detection, as opposed to the “simple database approach” in which the grouping is computed first. Any plate that does not match one of these configurations is rejected from the set of candidate plates.

In response to determining a corresponding validated candidate plate, the computer program adds 3006 the candidate plate to the set of candidate plates. In response to determining no corresponding validated candidate plate, the computer program disregards 3008 the candidate plate.

In some implementations, the computer program generates a ranking for the candidate plates, e.g., the generating 2712. A rank of each candidate plate is assigned with respect to each other candidate plate of the candidate plates and corresponding to (A) a number of preserves (whether user-selected preserves or previously selected plates acting as preserves) contacting the candidate plate and (B) a classification of the predefined plate configuration in the repository. The computer program assigns a ranking for the candidate plates in each iteration of the candidate plate generation/selection process. In other words, the ranking is updated for the updated set of candidate plates and to reflect the forming candidate solution including previously selected candidate plates.

Table (3) represents various features that the computer program can implement (e.g., at different weights) to score each of the candidate plates.

TABLE 3

| | |
|---|---|
| Grouping size | The number of preserves or other plates included |
| | in the grouping associated with this Plate. |
| Configuration | The rank or priority of the configuration that |
| rank | generated (or filtered) this candidate plate. |
| Obstacle | Penalty for the number and/or area of obstacles |
| intersection | intersecting this plate |
| score | |
| Transformation | Bonus for reflections about preserves, obstacles, |
| score | or derived keep-outs (bodies attached to preserve |
| | faces). Bonus is higher for separate reflected |
| | bodies (i.e., body A reflected about the plane |
| | matches body B) and lower for self-reflections |
| | (i.e., Body A reflected about the plane matches |
| | body A). |
| Symmetry | Bonus if this plate is the midplane between two |
| bonus | other plates |
| Preserve | Scores the intersection between this plate and |
| intersection | an intersecting preserve or previously selected |
| quality (e.g., | plate based on the angle difference between the |
| in the database | average face normal of the preserve and the plate |
| filtered | normal and the degree to which the plate midplane |
| approach only) | evenly divides the preserve in two, with a bonus |
| | for planar preserves coplanar with a top/bottom face |

In some implementations, the computer program selects, from the ranked set of candidate plates, a candidate plate to form the candidate solution, e.g., the selecting 2714. Each of the “simple database approach” and “database filtered approach” select a first candidate plate to include in the candidate solution before proceeding to determining if all preserves are connected in the candidate solution.

In some implementations, e.g., in the simple database approach, the computer program adds a first/top candidate plate to the accepted list of candidate plates included in the candidate solution. The computer program additionally adds the first/top candidate plate to a list of the preserves, while the preserves which were in the grouping which created the selected candidate plate are removed from the preserves list.

In some implementations, e.g., in the database filtered approach, the computer program can include all candidate plates generated based on global and local symmetry to form the candidate solution in a first iteration of the producing of the candidate solution, e.g., producing 2704 of the candidate solution.

In some implementations, e.g., in the simple database approach, the computer program can produce, e.g., produce 2704, a first candidate solution in a first pass where candidate plates are allowed to be generated with any valid thickness as described with reference to FIGS. 26A-26B. The computer program can then produce 2704 a second candidate solution in a second pass starting from the same initial condition except that all candidate plates are created with a uniform thickness equal to the thinnest plate created in the first pass. This can ensure the results shown to the user always have uniform thickness.

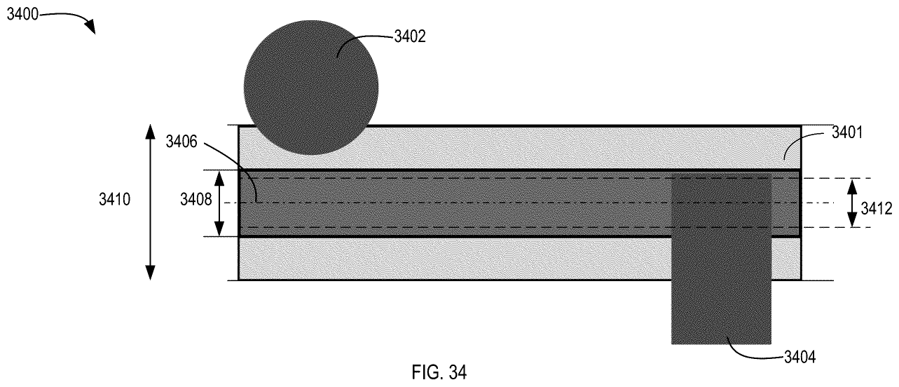

In some implementations, the computer program can adjust the thickness of a candidate plate in response to the presence of an obstacle in the vicinity of the candidate plate. FIG. 34 depicts an example 3400 of an obstacle-driven thickness adjustment for a candidate plate. Example 3400 includes a candidate plate 3401 having an initial thickness 3410 and obstacles 3402 and 3404. Initial thickness 3410 can be set at a default maximum thickness. Obstacle 3402 does not cross the midplane 3406 of the plate 3401 and obstacle 3404 does cross the midplane 3406 of plate 3401. The thickness of each of the candidate plates forming the candidate solution can have an initial thickness value, e.g., thickness 3410 of candidate plate 3401. The computer program can determine an intersection of the candidate plate with obstacle(s), e.g., obstacles 3402 and 3404. In response to determining the intersection, the computer program can adjust the initial thickness of the first candidate plate to an updated thickness 3408 such that the candidate plate having the updated thickness does not intersect with the obstacle 3402 (which did not cross the midplane 3406), and where the updated thickness is greater than a minimum thickness 3412 value for the candidate plate.

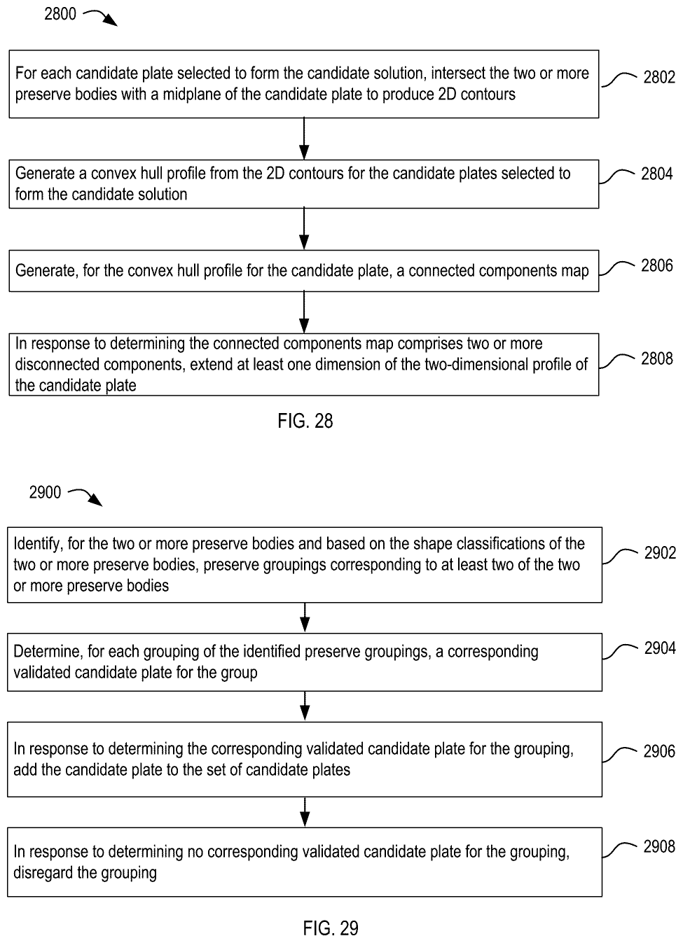

FIG. 28 is a flow diagram of an example of a process 2800 for disconnection prevention using a connected components map. For each candidate plate selected to form the candidate solution, the computer program intersects 2802 the two or more preserves with a midplane of the candidate plate to produce 2D contours. The computer program generates 2804 a convex hull profile from the 2D contours for the candidate plates selected to form the candidate solution, and generates 2806, for the convex hull profile for the candidate plate, a connected components map.

In response to determining the connected components map includes two or more disconnected components, the computer program extends 2808 at least one dimension of the two-dimensional profile of the candidate plate, e.g., plate profile 1106 as depicted in FIG. 11A. After selecting an initial plate profile, the computer program determines if all entities in the candidate plate's grouping are connected. If they are not (i.e., the plate's profile is broken into two or more disconnected components), the computer program re-runs the convex hull algorithm used to produce the plate profile but also includes an offset of the obstacle intersections with the midplane in the computation, e.g., plate profile 1116 as depicted in FIG. 11B. In some cases, adding the obstacle to the convex hull does not resolve the disconnection (e.g., because the obstacle forms a complete loop around one or more preserves). In such cases, the candidate plate cannot avoid a disconnection and the computer program rejects the candidate plate and continues to evaluate the next highest ranking candidate plate.

In some implementations, the computer program performs additional disconnection prevention checks after all candidate plates forming the candidate solution are selected for inclusion using one of the other disconnection prevention approaches described in this specification. In some implementations, the computer program may determine that a disconnection is not resolvable using the available candidate plates that meet one of the accepted configurations. In such cases, the computer program can implement a pathfinding disconnection resolution, e.g., as described with reference to FIG. 21B to add additional plates and resolve any remaining disconnections.

In some implementations, the shape synthesis computer program produces the candidate solution by determining a number of connected components in the candidate solution for each candidate plate. FIG. 31 is a flow diagram of an example of a process 3100 for filtering plates, e.g., in the filtered database approach. The computer program can implement process 3100 as each top-ranking candidate plate is selected for inclusion in the candidate solution to verify if the candidate plate improves the connectivity of the overall candidate solution. The computer program determines 3102 the first number of connected components in the candidate solution excluding the candidate plate and determines 3104 a second number of connected component in the candidate solution including the candidate plate. In response to determining the second number is equal to the first number, the computer program excludes 3106 the candidate plate from the candidate solution.

### Additional Embodiments

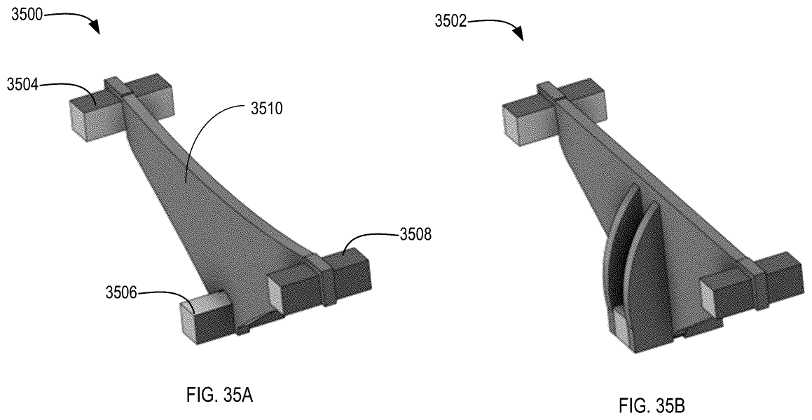

In some implementations, the shape synthesis computer program produces a candidate solution including a non-intuitive single candidate plate. In other words, fewer than all of the approaches described here in detail yields a single plate solution, and where at least one of the approaches disagrees with a number of candidate plates to form the candidate solution. For example, FIG. 35A depicts an example 3500 of a non-intuitive single-plate solution including plate 3510 for a set of preserves 3504, 3506, 3508 and using a first approach (e.g., static approach), where a second approach yields a multiple-plate solution for the same set of preserves (e.g., dynamic approach). The solution depicted in example 3502 of FIG. 35B includes a three-plate solution which can result from the dynamic approach algorithm not considering the single plate to acceptably contact (e.g., a threshold contact) one or more of the faces of the preserves. Because the plate generation, plate selection, and plate ranking of each of the approaches varies, a non-intuitive result can be generated by one or more of the approaches for a given set of preserves.

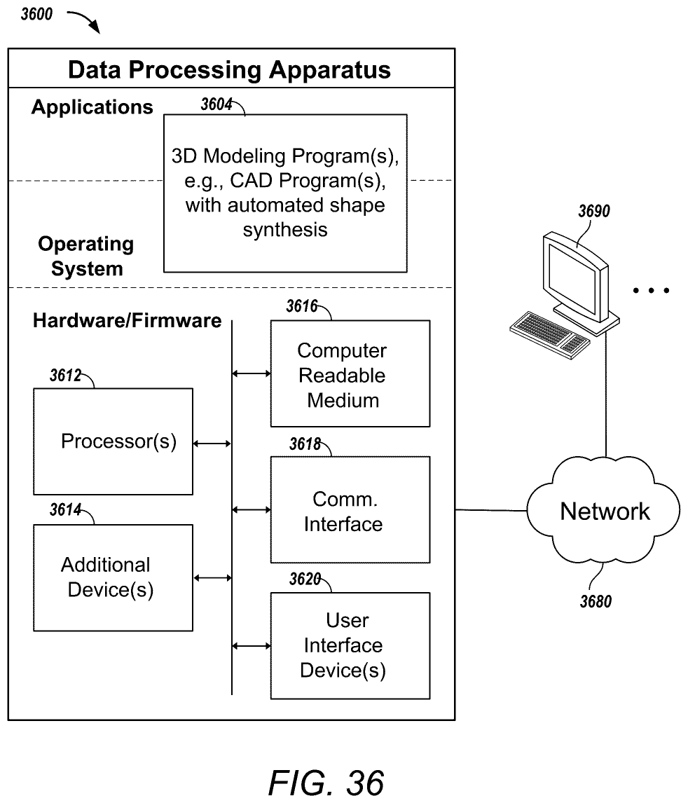

FIG. 36 is a schematic diagram of a data processing system including a data processing apparatus 3600, which can be programmed as a client or as a server. The data processing apparatus 3600 is connected with one or more computers 3690 through a network 3680. While only one computer is shown in FIG. 36 as the data processing apparatus 3600, multiple computers can be used. The data processing apparatus 3600 includes various software modules, which can be distributed between an applications layer and an operating system. These can include executable and/or interpretable software programs or libraries, including tools and services of one or more 3D modeling programs 3604 that implement connectivity control, as described above. Thus, the 3D modeling program(s) 3604 can be CAD program(s) 3604 (such as CAD program(s) 116) and can implement one or more shape synthesis, plate-like shape generation, automated shape generation, etc. Further, the program(s) 3604 can potentially implement manufacturing control operations (e.g., generating and/or applying toolpath specifications to effect manufacturing of designed objects). The number of software modules used can vary from one implementation to another. Moreover, the software modules can be distributed on one or more data processing apparatus connected by one or more computer networks or other suitable communication networks.

The data processing apparatus 3600 also includes hardware or firmware devices including one or more processors 3612, one or more additional devices 3614, a computer readable medium 3616, a communication interface 3618, and one or more user interface devices 3620. Each processor 3612 is capable of processing instructions for execution within the data processing apparatus 3600. In some implementations, the processor 3612 is a single or multi-threaded processor. Each processor 3612 is capable of processing instructions stored on the computer readable medium 3616 or on a storage device such as one of the additional devices 3614. The data processing apparatus 3600 uses the communication interface 3618 to communicate with one or more computers 3690, for example, over the network 3680. Examples of user interface devices 3620 include a display, a camera, a speaker, a microphone, a tactile feedback device, a keyboard, a mouse, and VR and/or AR equipment. The data processing apparatus 3600 can store instructions that implement operations associated with the program(s) described above, for example, on the computer readable medium 3616 or one or more additional devices 3614, for example, one or more of a hard disk device, an optical disk device, a tape device, and a solid-state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship with each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

What is claimed is:

1. A method comprising:
obtaining, by a shape synthesis computer program, two or more specified regions of geometry defined in a data structure used by the shape synthesis computer program;
producing, by the shape synthesis computer program, candidate solutions, each candidate solution of the candidate solutions produced using a different plate generation algorithm to synthesize plates that join the two or more specified regions of geometry with each other through the plates, each of the plates is defined by a base plane, a two-dimensional profile, and a thickness, and wherein the candidate solutions represent new geometry defined in the data structure;
providing, by the shape synthesis computer program and for presentation in a user interface, the candidate solutions and controls to select one or more of the candidate solutions for use in manufacturing one or more physical structures corresponding to the selected one or more candidate solutions using one or more computer-controlled manufacturing systems, or for use in displaying the selected one or more candidate solutions on a display screen.

2. The method of claim 1, further comprising:
receiving, by the shape synthesis computer program and through the user interface, a selection of a candidate solution of the presented candidate solutions.

3. The method of claim 1, wherein the two or more specified regions of geometry comprise two or more preserves, and the obtaining comprises receiving at least one obstacle through which the two or more preserves cannot be joined.

4. The method claim 1, wherein the producing comprises synthesizing, by the shape synthesis computer program, candidate plates that join the two or more specified regions of geometry with each other through the plates, wherein the synthesizing comprises:
generating a shape incorporating the two or more specified regions;
applying, to the generated shape incorporating the two or more specified regions, a numerical simulation to obtain a field of interest for the generated shape; and
selecting at least one of the candidate plates to join the two or more specified regions in response to the field of interest.

5. The method of claim 1, wherein producing each candidate solution of the candidate solutions comprises:
generating, by the shape synthesis computer program, candidate plates, each of the candidate plates being arranged with respect to the two or more specified regions and contacting at least one of the two or more specified regions;
ranking, by the shape synthesis computer program, the candidate plates based on a quality of contact between the at least one specified region and each candidate plate for the candidate plates; and
selecting, by the shape synthesis computer program and from the ranked candidate plates, at least two of the candidate plates to include in the candidate solution, wherein each of the two or more specified regions contact at least one of the at least two candidate plates.

6. The method of claim 5, wherein selecting the at least two candidate plates to include in the candidate solution comprises selecting a first candidate plate having a default thickness and comprising at least two layers, wherein each layer of the at least two layers of the first candidate plate comprises a plate profile, and wherein the at least two layers are arranged with respect to each other to form the first candidate plate.

7. The method of claim 5, further comprising:
receiving, by the shape synthesis computer program and through the user interface, a selection of at least one candidate plate of the selected candidate solution and a re-selection request; and
selecting, by the shape synthesis computer program and using the selected at least one candidate plate and the re-selection request, at least two candidate plates to include in the candidate solution to produce the candidate solution.

8. The method of claim 5, further comprising producing an alternative candidate solution for the candidate solution, comprising:
assigning, to the ranked candidate plates, a secondary scoring criteria; and
re-ranking, by the shape synthesis computer program, the candidate plates based on a quality of contact between the at least one specified region and each candidate plate for the candidate plates and the secondary scoring criteria; and
selecting, by the shape synthesis computer program and from the ranked candidate plates, at least two of the candidate plates to include in the alternative candidate solution, wherein the alternative candidate solution differs from the candidate solution by at least one selected candidate plate.

9. The method of claim 5, further comprising ranking the candidate plates using base planes for the candidate plates, wherein candidate plates having base planes corresponding to one or more identified symmetry planes for the two or more specified regions are assigned a higher ranking than candidate plates having base planes not corresponding to the one or more identified symmetry planes.

10. The method of claim 5, wherein the selecting comprises iteratively selecting candidate plates to include in the candidate solution, and wherein the ranking further comprises ranking the candidate plates using an angle of intersection of the candidate plate with each previously selected candidate plate of the candidate plates.

11. The method of claim 5, wherein the quality of contact between the at least one specified region and the candidate plate is determined from a characteristic of an intersection between a midplane of the candidate plate with the at least one specified region.

12. The method of claim 11, wherein the characteristic of the intersection comprises (A) containment of the at least one specified region within the candidate plate or (B) a crossing of the at least one specified region of the midplane of the candidate plate.

13. The method of claim 5, wherein the selecting comprises iteratively selecting candidate plates to include in the candidate solution, and wherein the ranking further comprises ranking a candidate plate of the candidate plates based on an orientation of the candidate plate with respect to at least one other previously selected candidate plate.

14. The method of claim 13, wherein the orientation of the candidate plate with respect to the at least one other candidate plate previously included in the candidate solution comprises (A) a degree of orthogonality of the candidate plate with respect to the at least one other candidate plate, or (B) a separation of a planar surface of the candidate to a parallel planar surface of the at least one other candidate plate.

15. The method of claim 5, wherein the producing further comprises:
determining at least one path connecting the two or more specified regions of interest through the selected two or more candidate plates; and
in response to determining that the at least one path does not connect the two or more specified regions of interest through the selected two or more candidate plates, selecting at least one additional candidate plate to produce the candidate solution.

16. The method of claim 5, wherein the new geometry represented by each of the one or more candidate solutions are a first geometry, and wherein the producing further comprises
for a candidate plate of the at least two candidate plates forming the candidate solution, identifying intersecting regions between the candidate plate and one or more other candidate plates;
assigning, based on the identified intersecting regions, a primary or secondary relationship to each candidate plate with respect to each other candidate plate of the at least two candidate plates;
classifying, each identified intersecting region and based on the assigned primary or secondary relationship, as one of a set of junction types;
resolving each intersecting region using a classified junction type of the set of junction types; and
producing, from the resolved intersecting regions, an updated representation of a second geometry defined in the data structure and replacing the first geometry.

17. The method of claim 16, wherein classifying each identified intersecting region as one of the set of junction types comprises:
classifying the identified intersecting region as one of (A) a “T” junction comprising a first plate bounded by a second plate where the second plate is not bounded by the first plate, (B) an “L” junction where two plates are mutually bounded by each other, and (C) an “X” junction where two plates intersect without forming a bounding relationship.

18. The method of claim 5, wherein producing each candidate solution of the candidate solutions comprises providing the candidate solution including at least one candidate plate as input to an automatic three-dimensional (3D) geometry generation process comprising:
generating an input to the automatic 3D geometry generation process comprising, for each candidate plate of the at one candidate plate of the selected candidate solution, a planar or quasi-planar mesh representation or embedding of the two-dimensional profile of the candidate plate along a midplane of the candidate plate; and
providing the input to the automatic 3D geometry generation process.

19. The method of claim 18, wherein the generating the input for each of the at least two candidate plates comprises generating a 2D mesh representation comprising (A) a 2D level set representation, (B) a 2D surface mesh, or (C) a 2D grid comprising a discrete representation of the candidate plate.

20. The method of claim 19, wherein generating the 2D mesh representation comprises removing a selected region of a 2D mesh representation of the 2D mesh representations comprising:
generating a connected components map of all interior mesh elements of the 2D mesh representation;
identifying a selected region to remove from the 2D mesh representation by determining, for each connected component in the connected components map, (A) a number of preserves and plate intersections contacted by the connected component, (B) a fraction of interior mesh elements in the connected component which are not also contained in an intersection or preserve, and (C) whether the connected component contacts a preserve which is not contacted by any other plates in the 2D mesh representation; and
removing, based on the identifying, connected components corresponding to the selected region.

21. The method of claim 20, wherein removing the selected region further comprises:
generating, plate boundaries for the candidate plates;
intersecting the 2D mesh representation with a half space defined by a bounding plane for the plate boundaries; and
removing, based on the intersection, the selected regions.

22. A method comprising:
receiving, by a shape synthesis computer program, two or more preserves defined in a data structure used by the shape synthesis computer program;
producing, by the shape synthesis computer program, a candidate solution by synthesizing plates that join the two or more preserves with each other through the plates, wherein each of the plates is defined by a base plane, a two-dimensional profile, and a thickness, and wherein the candidate solution represents a new geometry defined in the data structure, wherein the producing comprises
assessing preserve geometry for each of the two or more preserves;
generating, from the two or more preserves, an initial shape inclusive of the two or more preserves;
generating, based on the preserve geometries of the two or more preserves, a set of candidate plates, wherein each candidate plate contacts at least one of the two or more preserves;
selecting, from the set of candidate plates, at least two candidate plates to form the candidate solution; and
providing, by the shape synthesis computer program, the candidate solution for use in manufacturing a physical structure corresponding to the candidate solution using one or more computer-controlled manufacturing systems, or for use in displaying the candidate solution on a display screen.

23. The method of claim 22, wherein generating, based on the preserve geometries of the two or more preserves, the set of candidate plates comprises generating a symmetry plate having a midplane aligned with a global or local symmetry plane of the two or more preserves.

24. The method of claim 23, wherein generating, based on the preserve geometries of the two or more preserves, the set of candidate plates comprises:
generating, for the two or more preserves, surface mesh clusters for surface meshes corresponding to the two or more preserves; and
generating at least one candidate plate from the surface mesh clusters, comprising
setting an orientation of a midplane of the candidate plate using a cluster normal for a surface mesh cluster of the surface mesh clusters; and
setting a location of the candidate plate using a centroid of facets of one or more preserves selected for inclusion in the surface mesh cluster.

25. The method of claim 24, wherein the selecting further comprises:
scoring each candidate plate of the set of candidate plates, wherein a score of the candidate plate with respect to each other candidate plate of the set of candidate plates corresponds to (A) a number of preserves contacting the candidate plate, and/or (B) a fractional area of the preserve having a surface normal direction that is parallel, anti-parallel, or perpendicular to the normal direction of the surface mesh cluster of the candidate plate; and
selecting, by the shape synthesis computer program and from the scored candidate plates, the at least two candidate plates to include in the candidate solution.

26. The method of claim 22, wherein the thickness of the candidate plate comprises an initial thickness, and the method further comprises:
adjusting at least one of (A) a first location of the first surface, and (B) a second location of the second surface with respect to the base plane, wherein the adjusting comprises contacting at least one of the first surface and the second surface with one or more preserves, and wherein the adjusting comprises updating the thickness of the candidate plate to define an updated thickness; and
updating a location of the base plane in response to the adjusting of the at least one of the first surface and the second surface.

27. The method of claim 22, wherein generating, based on the preserve geometries of the two or more preserves, the set of candidate plates comprises:
classifying each preserve of the two or more preserves into shape classifications as at least one of (A) flat; (B) extruded and (C) other; and
generating candidate plates based on the classification of the two or more preserves.

28. The method of claim 27, wherein selecting, from the set of candidate plates, the at least two candidate plates to form the candidate solution comprises, for each candidate plate:
determining, from the classification of each preserve used to generate the candidate plate, a quality of contact between the candidate plate and at least one preserve as one of (A) acceptable contact, (B) unacceptable contact, and (C) not intersecting; and
selecting, from the quality of contact of each of the set of candidate plates, the at least two candidate plates to form the candidate solution.

29. The method of claim 22, wherein the selecting further comprises:
scoring the candidate plates based on a degree of intersection between a midplane of the candidate plate with at least one preserve wherein the degree of intersection comprises (A) containment of the at least one preserve within the candidate plate or (B) a crossing of the at least one preserve of the midplane of the candidate plate; and
selecting, by the shape synthesis computer program and from the scored candidate plates, the at least two candidate plates to include in the candidate solution.

30. The method of claim 22, wherein the selecting further comprises:
assigning, for each of the set of candidate plates, a score to the candidate plate, the score comprises (A) an intrinsic score and/or (B) a context score,
wherein the intrinsic score comprises a static ranking of the candidate plate with respect to each other candidate plate of the set of candidate plates, and
wherein the context score comprises a dynamic ranking of the candidate plate with respect to at least one other candidate plate of the set of candidate plates selected to form the candidate solution; and
selecting a candidate plate of the set of candidate plates using the score of the candidate plate to form the candidate solution.

31. The method of claim 22, further comprising extending a thickness of each of two preserve surfaces of at least one preserve comprising:
extruding each triangle of triangles forming the preserve surface along a normal direction; and
joining the two preserve surfaces to generate a solid body.

32. The method of claim 22, wherein generating the initial shape inclusive of the two or more preserves comprises generating a convex hull.

33. The method of claim 32, further comprising:
generating an updated convex hull inclusive of the two or more preserves and the at least two candidate plates forming the candidate solution using a model of intersecting regions of the at least two candidate plates as additional input.

34. The method of claim 33, comprising generating the model of the intersecting regions of the at least two candidate plates as boxes oriented along an intersection vector of the intersection region and covering an extent of the convex hull projected onto the intersection vector.

35. The method of claim 22, further comprising:
intersecting the initial shape with a midplane of each candidate plate of the at least two candidate plates;
determining, from the intersections, connected components for each of the at least two candidate plates;
generating, for each of the connected components, an intersecting connected components map between the connected components for the at least two candidate plates; and
in response to determining a disconnection in the intersecting connected components map
generating a set of connecting candidate plates, and
selecting an additional connecting plate from the set of connecting candidate plates to form an updated candidate solution.

36. The method of claim 35, further comprising:
determining, for the at least two candidate plates and the additional connecting plate forming the candidate solution, a system score;
ranking each of a remaining set of connecting candidate plates based on an increase to the system score from including the connecting candidate plate in the candidate solution; and
selecting, for inclusion in the candidate solution, an additional connecting plate using the ranking of the remaining set of connecting candidate plates.

37. The method of claim 22, further comprising:
identifying, from the initial shape and the at least two candidate plates forming the candidate solution, regions of the initial shape included within a volume defined by an intersection between each of the at least two candidate plates and the initial shape;
identifying paths connecting the two or more preserves;
classifying each of the identified paths based on (A) a fidelity of the path to a volume of the initial shape, and (B) a fidelity of the path to the identified regions; and
in response to the classifications of the identified paths
extending the initial shape to generate an updated shape, or
selecting an additional candidate plate to form the candidate solution.

38. The method of claim 22, further comprising:
analyzing a quality of intersection for each of one or more intersections between two or more of the at least two candidate plates within the initial shape;
analyzing a quality of contact between each of the at least two candidate plates and the two or more preserves; and
in response to the quality of intersection and the quality of contact each meeting at least a threshold value, providing, by the shape synthesis computer program, the candidate solution.

39. The method of claim 22, wherein selecting, from the set of candidate plates, at least two candidate plates to form the candidate solution comprises:
identifying symmetry planes for the two or more preserves; and
selecting at least one candidate plate aligned with a symmetry plane of the symmetry planes.

40. A method comprising:
receiving, by a shape synthesis computer program, two or more preserves defined in a data structure used by the shape synthesis computer program;
producing, by the shape synthesis computer program, a candidate solution by synthesizing candidate plates that join the two or more preserves with each other through the candidate plates, wherein each of the candidate plates is defined by a base plane, a two-dimensional profile, and a thickness, and wherein the candidate solution represents a new geometry defined in the data structure, wherein the producing comprises
determining a number of preserves in a current set of preserves defined in the data structure; and
in response to determining the number of preserves in the current set of preserves is greater than or equal to two, iteratively selecting candidate plates for inclusion in the candidate solution, comprising
classifying each preserve of the current set of preserves defined in the data structure into shape classifications based in part on one or more symmetries of the preserve,
selecting a set of base planes for a set of candidate plates from predefined plate configurations stored in a repository and based on the shape classifications of the current set of preserves,
generating a ranking for the candidate plates, wherein a rank of each candidate plate with respect to each other candidate plate of the candidate plates corresponds to (A) a number of the current set of preserves contacting the candidate plate and (B) a classification of the predefined plate configuration in the repository,
selecting, from the ranked set of candidate plates, a candidate plate to form the candidate solution, and
updating the current set of preserves to include the candidate plate as a new preserve in a next iteration,
in response to determining the number of preserves in the current set of preserves is less than two, providing, by the shape synthesis computer program, the candidate solution for use in manufacturing a physical structure corresponding to the candidate solution using one or more computer-controlled manufacturing systems, or for use in displaying the candidate solution on a display screen.

41. The method of claim 40, wherein updating the current set of two or more preserves to include the candidate plate comprises:
for a first preserve having at least a threshold contact with the candidate plate, generating a second preserve comprising the first preserve and the candidate plate, or
defining a new preserve comprising the candidate plate.

42. The method of claim 40, further comprising:
for each candidate plate selected to form the candidate solution, intersecting the two or more preserves with a midplane of the candidate plate to produce 2D contours;
generating a convex hull profile from the 2D contours for the candidate plates selected to form the candidate solution;
generating, for the convex hull profile for the candidate plate, a connected components map; and
in response to determining the connected components map comprises two or more disconnected components, extending at least one dimension of the two-dimensional profile of the candidate plate.

43. The method of claim 40, wherein the thickness of each of the candidate plates forming the candidate solution comprises an initial thickness value, and wherein, for each candidate plate forming the candidate solution:
determining an intersection of the candidate plate with an obstacle; and
in response to determining the intersection, adjusting the initial thickness of the candidate plate to an updated thickness such that the candidate plate having the updated thickness does not intersect with the obstacle, and wherein the updated thickness is greater than a minimum thickness value for the candidate plate.

44. The method of claim 43, wherein the thickness of each of the candidate plates forming the candidate solution comprises a same thickness value corresponding to a smallest value of an updated thicknesses for the candidate plates.

45. The method of claim 40, wherein selecting the set of candidate plates comprises:
identifying, for the two or more preserves and based on the shape classifications of the two or more preserves, preserve groupings corresponding to at least two of the two or more preserves;
determining, for each grouping of the identified preserve groupings, a corresponding validated candidate plate for the group;
in response to determining the corresponding validated candidate plate for the grouping, adding the candidate plate to the set of candidate plates; and
in response to determining no corresponding validated candidate plate for the grouping, disregarding the grouping.

46. The method of claim 40, wherein selecting the set of candidate plates comprises:
generating, for the two or more preserves and based on the shape classifications of the two or more preserves, candidate plates based on one or more of (A) global symmetry of the two or more preserves, (B) axis-aligned planes at a center of gravity of the two or more preserves, (C) pairwise local symmetry of the two or more preserves, and (D) planes of clustered preserve triangles grouped by normal directions for the cluster; and
filtering each candidate plate of the candidate plates against a repository of validated candidate plates for the two or more preserves;
in response to determining a corresponding validated candidate plate, adding the candidate plate to the set of candidate plates; and
in response to determining no corresponding validated candidate plate, disregarding the candidate plate.

47. The method of claim 46, wherein the producing comprises:
including all candidate plates generated based on global and local symmetry to form the candidate solution.

48. The method of claim 40, further comprising:
determining a first number of connected components in the candidate solution excluding the candidate plate;
determining a second number of connected component in the candidate solution including the candidate plate; and
in response to determining the second number is equal to the first number, excluding the candidate plate from the candidate solution.
